(19) United States
(12) Patent Application Publication
(10) Pub. No.: US 2025/0361452 A1
(43) Pub. Date: Nov. 27, 2025

(54) REACTORS AND STRUCTURES FOR THE PREVENTION OF SOLID DEPOSITION

(71) Applicant: CZERO, INC., Goleta, CA (US)

(72) Inventors: Brett PARKINSON, Goleta, CA (US); Andrew CALDWELL, Goleta, CA (US); Samuel SHANER, Goleta, CA (US); Rosadriana ZELAYA, Goleta, CA (US); Joshua RODRIGUEZ, Goleta, CA (US); Steve CALDERONE, Goleta, CA (US); Zach JONES, Goleta, CA (US); Eric W. MCFARLAND, Goleta, CA (US)

(21) Appl. No.: 18/872,525

(22) PCT Filed: Jun. 6, 2023
(86) PCT No.: PCT/US2023/024605

§ 371 Date: Dec. 6, 2024

Related U.S. Application Data
(60) Provisional application No. 63/349,315, filed on Jun. 6, 2022.

(51) Int. Cl. C10G 9/16; B01J 8/02; B01J 8/06; B01J 12/02; B01J 19/24

(52) U.S. Cl. CPC C10G 9/16; B01J 8/025; B01J 8/067; B01J 12/02; B01J 19/2425; B01J 19/247; B01J 2219/00135; B01J 2219/00159; B01J 2219/00247; B01J 2219/00252

(57) ABSTRACT

A reactor includes a reactor vessel, a liquid film in contact with and coating at least a portion of a surface of an interior of the reactor vessel, and one or more reaction products in contact with the liquid film within the reactor vessel. The liquid film is configured to wet at least a portion of the surface of the interior of the reactor vessel, and the liquid film is formed from a material that inhibits the deposition of at least one reaction product of the one or more reaction products on the surface of the interior of the reactor vessel.

### CROSS-REFERENCE TO RELATED APPLICATIONS

This application claims priority to U.S. Provisional Patent Application No. 63/349,315 filed on Jun. 6, 2022 and entitled, “REACTORS AND STRUCTURES FOR THE PREVENTION OF SOLID DEPOSITION,” which is incorporated herein in its entirety for all purposes.

### STATEMENT REGARDING GOVERNMENTALLY SPONSORED RESEARCH OR DEVELOPMENT

None.

### BACKGROUND

In a variety of chemical processes, gas phase reactants can produce solid products that need to be removed from the reactor without the solid products adhering to internal structures within the reactor. The solid phase products can be desired products or side products. For example, the prevention of carbon deposition (coking) in the reaction of hydrocarbons is of major importance in many processes. It can be difficult to add heat at high temperatures to many hydrocarbon streams without depositing solid carbon on the heat transfer surfaces.

### SUMMARY

The present invention relates to reactor designs, materials, and methods for preventing deposition of solids associated with chemical processes on the interior surfaces of chemical process equipment.

In a preferred embodiment, a tubular chemical reactor and the materials comprising it are specified such that a liquid is caused to adhere to all reactor surfaces of a specific composition selected together with the materials comprising the solid surfaces within the reactor, preventing the production of solid reaction products on the solid surface, or washing off any produced products on the solid surfaces.

In another embodiment, a particulate solid bed is configured such that reacting gas moves through the solid particulates at a high velocity, creating a channel in which the solid-forming reaction occurs. The particulates formed in the channel contribute to the solid bed and protect reactor internals from build-up of solid reaction products.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1 schematically illustrates the changing flow regimes from bubbles to annular flow with wetting of tube walls.

FIG. 2 schematically illustrates a tubular reactor constructed of a material or materials, that can be wetted by a stable liquid at high temperatures according to some embodiments.

FIG. 3 schematically illustrates another tubular reactor constructed of a material or materials, that can be wetted by a stable liquid at high temperatures according to some embodiments.

FIGS. 4A and 4B schematically illustrates a tubular reactor constructed of a material or materials, that can be wetted by a stable liquid at high temperatures and configured as in a traditional hydrocarbon cracking furnace according to some embodiments.

FIGS. 5A-5C schematically illustrates still another tubular reactor constructed of a material or materials, that can be wetted by a stable liquid at high temperatures and heated electrically according to some embodiments.

FIGS. 6A and 6B schematically illustrate a multitube reactor constructed of a material or materials that can be wetted by a stable liquid at high temperatures heated with a heat transfer fluid or electrically according to some embodiments.

FIG. 7 schematically illustrates a reactor configuration in which heat can be supplied to the fluid prior to introduction of the feed gas according to some embodiments.

FIGS. 8A and 8B schematically illustrate a porous wall reactor in which an externally heated and circulated fluid is pressurized through the wall to provide a continuously renewed surface according to some embodiments.

FIG. 9 schematically illustrates how heat integration can be achieved in a porous wall reactor with three liquid reservoirs heated electrically or chemically according to some embodiments.

FIGS. 10A and 10B schematically illustrate a packed trickle bed wetted by liquid to prevent solid accumulation electrically according to some embodiments.

FIG. 11 illustrates a spouting solid bed reactor with a channel through the solid where solid products from the reaction are prevented from contacting structural materials.

FIG. 12 schematically illustrates a spouting solid bed reactor with circulating solids containing products which are separately removed from the bed according to some embodiments.

FIG. 13 schematically illustrates a spouting solid bed reactor whereby a blanket gas is introduced to shield the reactor wall from reactant gases according to some embodiments.

FIG. 14 schematically illustrates a reactor with multiple separate spouting solid beds heated external to the solid containing tubes according to some embodiments.

FIG. 15 schematically illustrates a reactor with multiple spouts within a single solid bed with internally placed heating elements according to some embodiments.

FIGS. 16A and 16B schematically illustrate how heat integration can be achieved in a circulating solid bed whereby solid flow is countercurrent to gas flow through the reactor center according to some embodiments.

FIG. 17 schematically illustrates the U-tube reactor configuration as used in some examples.

FIG. 18 shows images of wetted wall experiment according to some embodiments.

FIG. 19 shows images of reactor from wetted wall experiment according to some embodiments.

FIGS. 20A and 20B show images of a tungsten containing coating on graphite according to some embodiments.

FIGS. 21A and 21B show images of wetting of specific surface coating electrically according to some embodiments.

FIGS. 22A and 22B show cross sectional images of specific surface coating electrically according to some embodiments.

### DETAILED DESCRIPTION

Use of high temperature liquids including molten salts and/or molten metals as heat transfer and reaction media allows facile heat addition to the liquid, and, provided the reactants do not react irreversibly with the liquids, the gas phase reactants can be contacted by and reacted in the presence of the liquid media. It has previously been difficult or impossible to prevent contact between the reactants and solid surfaces within the reactor, and when direct contact is made, a solid product may be deposited on the solid surfaces resulting in fouling or coking that can result in build up over time.

A ubiquitous problem in industrial applications is the fouling and deposition of reactor internal structures or heat exchange surfaces with solid materials produced in chemical reactions. The present systems and methods provide for the selection of liquids and solid surfaces for containment structures and walls that are stable within the reactor environment that can serve by design to prevent solid accumulation within the reactor. The present materials, systems, and methods also describe specific solid materials within the reactor with surface properties that support the adherence of liquid films (“wetting”) everywhere that reactions producing solid products occur within the reactor environment. As used herein, wetting refers to the formation of a liquid droplet with a contact angle of equal to or less than 90 degrees, and in some aspects the contact angle can be less than or equal to 60 degrees. By the formation of such a wetted layer on the solid surfaces, any solid reaction products are instead deposited on the liquid surface with little to no adherence to the interior solid surfaces of the reactor. The solid reaction products can be removed physically or be made to circulate to remove the solid reaction products from the wetted solid surfaces and/or reactor, preventing the accumulation of solids.

The preparation processes, materials, and reactor systems described herein can include specific combinations of liquids and solids selected based on their physical interactions which result in the liquid wetting the solid surfaces and preventing reaction product deposition on such solid surfaces. The processes and systems described herein can also include specific treatments or modifications of the solid surfaces that provide for liquid wetting.

Also disclosed herein is the use of solids that can act as fluids that can be present between a solid surface within the reactor and the reaction. The reaction products can then deposit on the fluidized or fluidizable solids to help prevent the deposition and buildup of reaction products on the solid surfaces.

Taking hydrocarbon processing as an illustrative example, few materials are resistant to fouling due to carbon deposition (e.g., coking) resulting from hydrocarbon decomposition. Several metals interact only weakly with carbonaceous species or hydrocarbons, for example, copper, gold, tin, gallium, and silver. At high temperatures (e.g., T>1100° C.) these metals are in the liquid state and remain weakly interacting with carbon or hydrocarbons. In the liquid state, the resistance to carbon deposition is aided by the absence of higher-energy surface defects.

An aspect of the systems and methods described herein is reactors and reactor materials that enable a thin liquid layer to exist on the surface of the components in the reaction environment. This liquid layer prevents the accumulation of carbon on the solid interior surfaces of the reactor. Common to the wetting of solid structures or components by liquids is the selection and preparation of materials which satisfy structural requirements of the reactor and can be wetted by a liquid film of the media. One aspect of this selection is an appropriate solid and liquid combination that promotes the formation of a stable wetted liquid layer at high temperatures (e.g., T>500° C.) and does not interact strongly with carbon or hydrocarbons. Another aspect disclosed herein is the use of reactor material surface morphology and surface coatings on other structural materials with appropriate length scales to enhance wetting by the molten media by capillary forces.

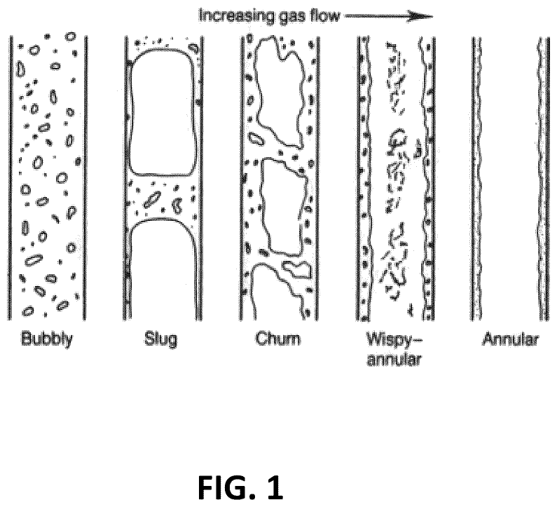

One aspect disclosed herein is the operation of reactors in regimes whereby a liquid layer is maintained on solid surfaces due to the hydrodynamics of the flow. FIG. 1 shows schematically how, when high gas velocities are achieved, gas bubbling up through a liquid transitions from a bubbling flow through slug flow, chum flow, and wispy-annular flow to a regime where the liquid resides on the surface of the solid outer wall of the reactor tube (annular flow), providing a liquid layer in contact with the gas phase. The specific flow regime can be established and maintained based on the relative liquid and gas flowrates using known techniques such as flow controllers, level sensors, and the like.

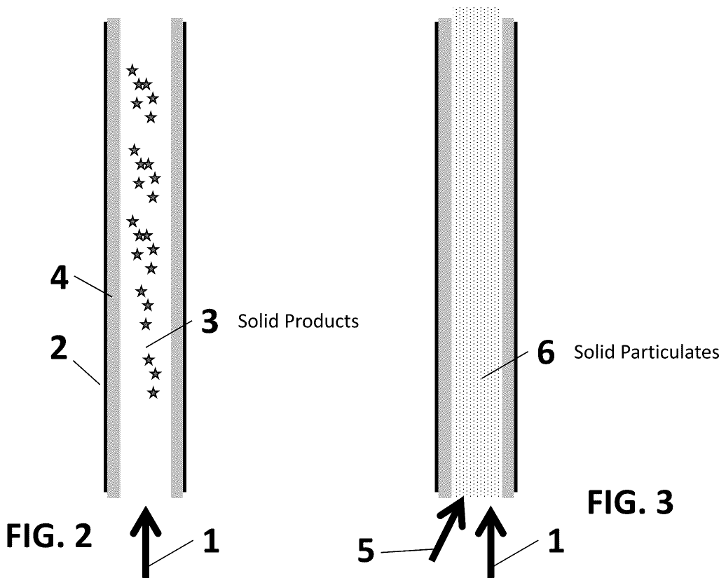

FIG. 2 shows schematically a tubular reactor with reactants 1 entering the conduit or tube 2, and producing a solid product 3, whereby the solids do not adhere to the liquid coating 4 on the wall of the tube 2. The solid product 3 can travel out of the reactor with the vapor phase species as a suspension. The liquid layer 4 can be periodically reapplied, depending on the rate of vaporization of the liquid. For example, the liquid layer can be applied through the introduction of the liquid into the feed to coat the walls, introduction as a falling film within the reactor, through submersion of the reactor walls, and/or through permeation of the liquid through the reactor walls, each as described in more detail herein.

As shown in FIG. 3, in some applications, for example the pyrolysis of hydrocarbons to produce solid carbon products, solid particulates 5 may be introduced along with the hydrocarbon feed 1 and serve as a solid scaffold 6 on which additional carbon can be deposited. In this application, the addition of the solid particulates 5 provides a preferential surface on which the solid products can deposit. This may allow the relative size of the solid particulates 5 to grow during the reaction.

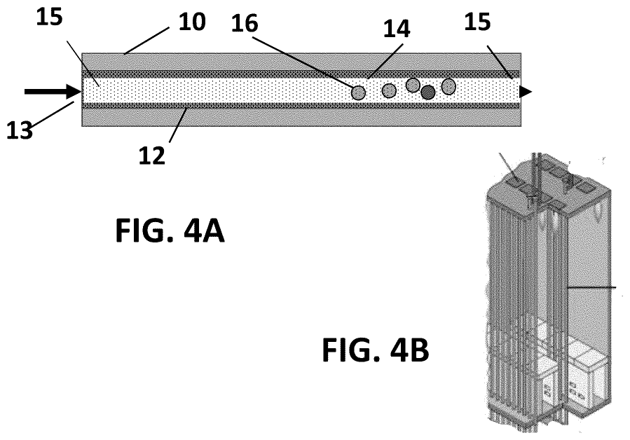

In some embodiments as shown in FIG. 4A, a tubular reactor 10 can be constructed of a material or materials that can be wetted by a stable liquid at high temperatures can be used to pyrolyze a feed gas of a reactant 13 such as a hydrocarbon (e.g., methane, etc.) and produce a solid carbon product 14. The solid carbon products 14 can be conveyed from the reactor in the product stream 15 at an appropriate linear velocity to prevent deposition of the carbon product on the liquid media surface 12. In some applications, for example, the pyrolysis of hydrocarbons producing solid carbon products, solid particulates 16 can be co-fed with the reactants 13 and serve as a solid scaffold on which additional carbon can be deposited. The reactor can be configured in a similar manner as commercial reformers or crackers as shown in FIG. 4B, where the tubes can be heated by a gas fired heater or using electrical resistance heating where the flow regime can be selected by modification of the gas linear velocity to achieve the desired liquid and gas flow regime.

In another embodiment of FIG. 4A, the reactor can be operated at lower linear velocities and close to the solidus temperature of the wetted liquid layer. A temperature decrease to below the solidus temperature of the wetted layer causes freezing of the liquid layer and severs any surface bonding between settled or deposited solids, and any carbon that has settled to the media surface can be removed by increasing the gas flow to change the flow regime of the gas and linear velocities.

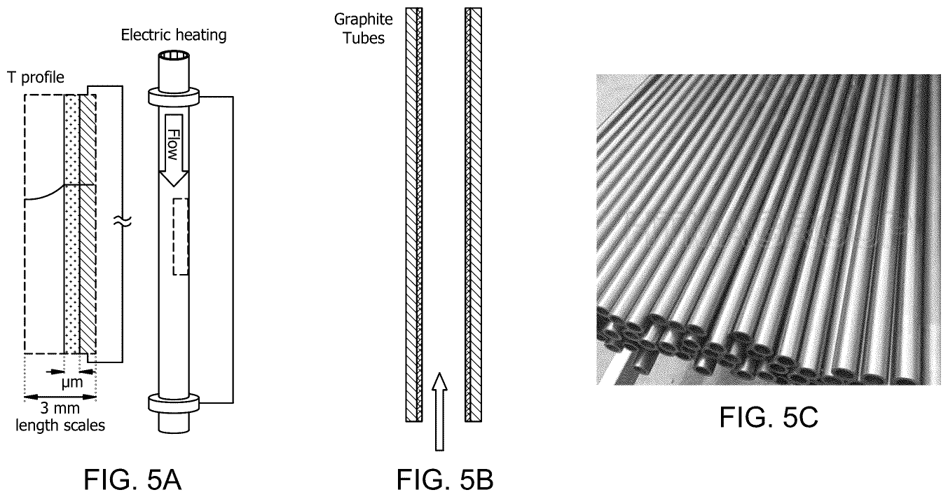

FIGS. 5A-5C demonstrate an example of an embodiment using resistance or inductive heating of a material. As shown, a conductive material capable of remaining as a solid at reaction temperatures can be heated by passing a current through the reactor wall material. In response to the electrical current, the reactor wall can heat up and maintain a liquid layer wetted on the internal surface during a reaction. While described as resistive heating, inductive heating of the reactor wall can also be used. Any suitable material can be used such as graphite, various metallic alloys, and the like. The resulting liquid disposed on the inner wall is shown schematically in FIG. 5B. Examples of reactor tubes such as graphite or alloy tubes is shown in FIG. 5C.

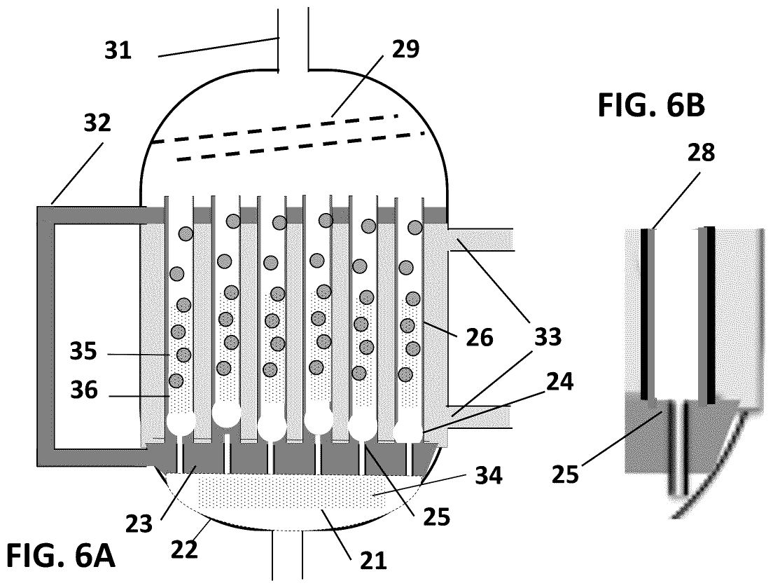

In another embodiment of the wetted wall reactor shown in FIG. 6A and FIG. 6B, gas phase reactants 21 can be introduced into a reactor vessel 22, filled with liquid medium 23. The gas phase reactants 21 can form bubbles by being passed through a nozzle or set of nozzles 25, which can release the resulting bubbles 24 into an array of tubes 26, bringing the liquid medium 23 into the tubes 26. The liquid medium 23 can be drafted into the tubes using a bubble lift and/or entrained by the gas phase reactants 21 passing through the nozzles 25. The bubble rise can be confined within the tube 26, which lifts the liquid and causes the liquid to flow out the top opening of the tube 26. The reactor can be configured in a similar manner as commercial reformers or crackers heated by a gas fired heater or using electrical resistance heating, where the flow regime detailed with respect to FIG. 1 can be selected by modification of the gas linear velocity and liquid circulation rate to achieve the desired liquid and gas flow regime. The reaction can produce solid products, which are prevented from contacting the solid surface of the walls of the tubes 26 by a wetting layer of liquid 28 adhering to the solid surface of the tubes 26.

In some applications, for example pyrolysis of hydrocarbons producing solid carbon products 35, solid particulates 34 can be co-fed together with the reactants 21 such as hydrocarbons to provide a solid scaffold 36 on which additional carbon can be deposited. As the reaction proceeds, the reaction products can exit the top of the liquid medium 23 or tube 26 bundle. The reaction products can be passed through a gas-liquid separator such as a demister 29, which separates liquid droplets entrained in the reaction products and returns the liquid media 23 to the liquid medium in the reactor vessel 22. The reaction products can leave the reactor through an exit 31. The lifting of the liquid medium 23 in the tubes 26 can cause the liquid to flow through and external circulation loop 32 before passing back to the base of the reactor vessel 22. For example, a weir, tray, or other catchment can be used to pass the liquid passing out of tubes back to the lower portion of the reactor vessel holding the liquid pool of the liquid medium 23. Heat can be added or removed from the liquid medium 23 in the external circulation loop 32, or directly to the tubes 26 through a separate process gas/liquid fluid 33, flowing around the outside of the tubes. Heat can be added by a number of heating options, including electrical (e.g., induction or resistance) or fired heaters, or a heat transfer fluid through tubular heat transfer surfaces.

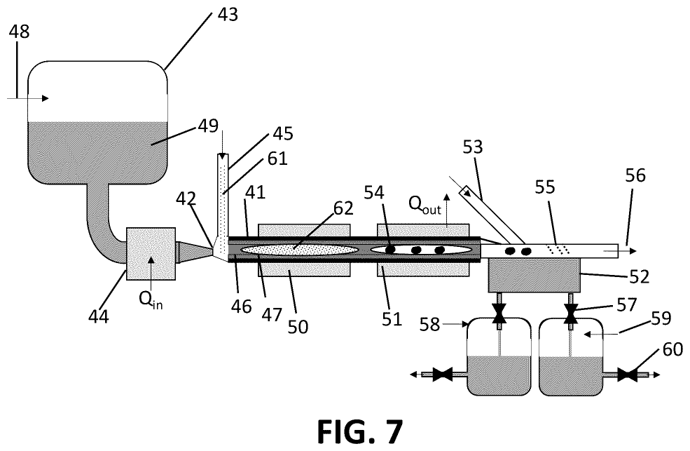

In yet another embodiment of the wetted wall reactor shown in FIG. 7, liquid media 49 can be co-fed to the wetted wall reactor system 41 by means of a pressurized injector nozzle 42, which can receive the liquid media from a liquid media reservoir 43. Heat can be added to the molten media 44 before mixing with the inlet reactant hydrocarbon 45 (e.g., methane) to provide sufficient sensible heat for the reaction occurring inside the wetted wall reactor 41. The thin molten media liquid 46 layer can be continuously renewed by co-injected media from the injector nozzle 42. The ratio of gas “slugs” 47 to molten media flowing through the reactor system 41 can be determined, at least in part, by the ratio of sensible heat between the molten media 44 and the required chemical energy of the hydrocarbon gas 45. The slug velocity in the system can be controlled by pressurizing the liquid media reservoir 43 with an inert gas 48 in the gas freeboard space. The slug and gas velocity can be set to determine the flow regime occurring within the wetted wall reactor 41. Additional heat can be added or withdrawn in the first high temperature reaction section 50. The reaction can produce solid products, which are prevented from contacting the solid surface of the tube walls of the wetted wall reactor 41 by a wetting layer of liquid 46 adhering to the solid surface of the tubes.

In some applications, for example pyrolysis of hydrocarbons producing solid carbon products in the form of solid particulates 54, together with the reactant hydrocarbons 45 a feed of solid particulates 61 can be co-fed with the reactants to provide a solid scaffold 62 on which additional carbon can be deposited. As the reaction proceeds, the reaction products can exit the end of the high temperature reaction section 50. The reaction products can be passed through a second cooling section 51 in which heat is exchanged to the molten media 44. The reaction products can exit the cooling section 51 and pass over a media disengagement pool 52 to facilitate disengagement of media droplets entrained from the liquid media between gas slugs 47. Additional recycle gas 53 can be added to increase the linear velocity of the solid particulates 54 and convey the particles through a liquid-phase demister 55, which is wetted by the molten media to disengage liquid droplets from the product stream 56. Liquid media in the disengagement pool 52 can be periodically drained to holding vessels 58 from the bottom of the pool through isolation valves 57. The media can be conveyed from the holding vessels 58 to the liquid media reservoir 43 by pressurization of the holding vessels 58 using an ancillary purge gas 59 to the vessel freeboard space through a secondary isolation valve 60. The reactor can be configured in a similar manner as commercial reformers or crackers heated by a gas fired heater or using electrical resistance heating.

In any of the embodiments detailed with respect to FIGS. 2-7, the tubes and/or tube sheets can be constructed from a material that is stable within the reaction environment and may be solid (e.g., as a rolled or extruded material) with a smooth surface, or alternatively, the material surface may also be advantageously altered to a woven, mesh, or otherwise porous structure to facilitate wettability or specific applications. In some embodiments, the draft tube material can be made from tubes, sheets, woven wires, etc. of refractory materials including molybdenum, niobium, tantalum, tungsten, and/or rhenium, as well as any alloys thereof. In some embodiments, the tube and tube sheet material are made from tubes, sheets, woven wires, etc., of refractory metal-carbides or oxides of molybdenum, niobium, tantalum, tungsten, rhenium, and/or alloys thereof. In some embodiments, the tube or tube sheet material can be made from tubes, sheets, woven wires, etc. of ceramic and ceramic-based composites including, but not limited to: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, and graphite, with a surface coating of refractory materials including molybdenum, niobium, tantalum, tungsten and/or rhenium and their alloys, metal-carbides or oxides to facilitate wettability or specific applications. In other embodiments, the tubes, sheets, woven wires, etc. can be made of composite materials with surface morphologies or structures that promote enhanced wetting. In other embodiments the internal structures may be structured packing formed as geometric shapes including tubes, spheres, and irregularly shaped bodies of these materials. The internal structures may also be perforated plates and combinations of perforated plates and geometric shapes.

In some embodiments, the liquid can be a molten metal containing one or more elements: Ag, Au, Sb, Sn, Bi, Ni, Cu, Fe, Pt, In, Pb, Pd, Co, Te, Rh, Ga, oxides thereof, and/or mixtures thereof. In some embodiments, the molten media can comprise a molten salt, a molten metal, or any combination thereof. In some embodiments, a salt mixture comprises one or more oxidized atoms (M)₊ₘ and corresponding reduced atoms (X)₋₁, wherein Mis at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂, MgCl₂, CaBr₂, MgBr₂ and combinations thereof. In yet another embodiment, the tube or tube sheet material can be prepared in-situ in the reactor by contacting the refractory metal directly with oxygen or carbon in a solid, gaseous, or dissolved state, which is in direct contact with the molten liquid.

In any of the embodiments described with respect to FIGS. 2-7, the reactor can operate at suitable conditions for the desired reaction to occur. In some embodiments, the temperature can be selected to maintain the molten media in the molten state such that the molten media is above the melting point of the composition while being below the boiling point. In some embodiments, the system can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. In some embodiments, the temperature can be operated just above the solidus temperature of the wetted media layer, and periodically lowered below the transition temperature to promote separation of any settled solid particulates from the reaction surface. The reactor can operate at any suitable pressure. In some embodiments the reactor may operate at higher pressures with an appropriate selection of the reactor configuration, operating conditions, and flow schemes, where the pressure can be selected to maintain a gas phase holdup and superficial gas velocity within the reactor.

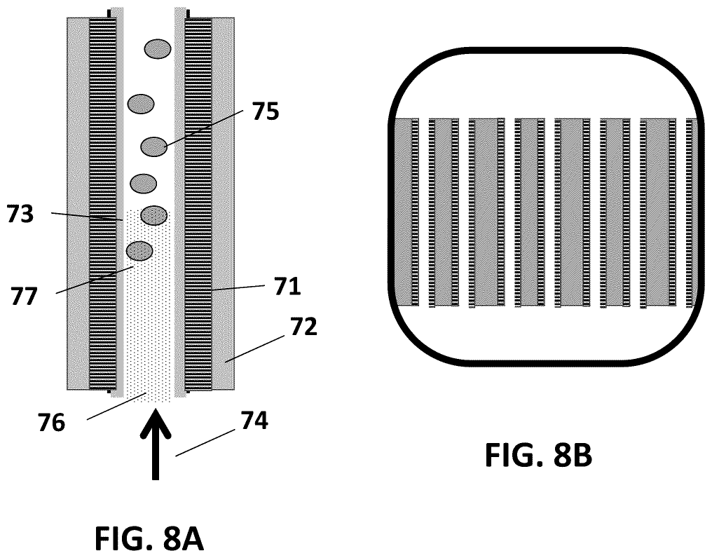

In another embodiment, FIG. 8A, the reactor wall 71 can be formed from a material with sufficient porosity and wettability to the liquid media that the reservoir of the hot liquid surrounding the walls 71 outside the reaction zone can be maintained at a pressure sufficient to allow the liquid to move through the wall and wet the reactor interior wall 73. The reactor material and structure can be selected to promote the interior wall wetting. The wetted interior wall 73 can be continuously replenished with liquid, and the liquid can gradually flow down the reactor walls due to gravity, counter current to the incoming gas feed 74. The solid carbon products 75 can be conveyed from the reactor in the product stream at an appropriate linear velocity to prevent deposition of the carbon product on the liquid media surface. The gas/liquid flow regime can be maintained by controlling the linear velocity of gas, and the pressure applied to the liquid side can be used to control the rate of permeation of liquid through the wetted wall. In some applications, for example pyrolysis of hydrocarbons producing solid carbon products, together with the reactant hydrocarbons a feed of solid particulates 76 can optionally be co-fed with the reactants to provide a solid scaffold 77 on which additional carbon can be deposited. The reservoir of the liquid 72 outside the tube can be heated by one of a number of heating options including electrical (induction or resistance), fired heaters, and/or a heat transfer fluid through tubular heat transfer surfaces. The external liquid reservoir 74 may also be circulated external to the main vessel interior. The individual reactor tube can be mounted in a tube sheet with pressurized liquid on the shell side, weeping across each tube as shown in FIG. 8B.

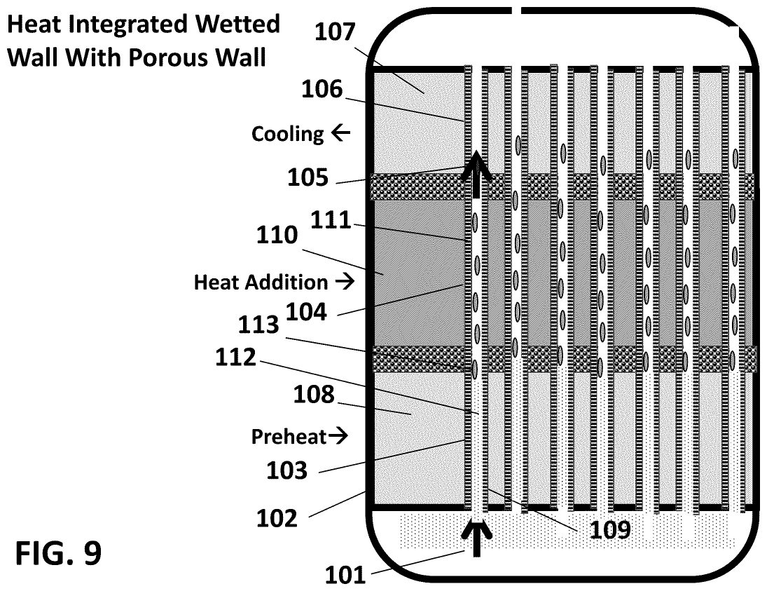

A feature of the porous wetted wall configuration is the ability to partially insulate a central reaction zone where the liquid can be maintained at a very high reaction temperature and have other zones at different temperatures. In some embodiments as shown in FIG. 9, heat integration may be achieved using a plurality of reservoirs of liquid, where three reservoirs of the liquid are shown in FIG. 9 as an exemplary embodiment. A primary reaction tube 109 can span across all three reservoirs of liquid. As the reactants 101 enter from the bottom of the main vessel 102, they can be pre-heated in the lower wetted wall section 103 and maintained at a temperature lower than the central reaction zone 104. The central reaction zone 104 is where the primary reaction can be performed and the heat 110 can be added to drive the reaction producing a solid product 105, whereby the solids do not adhere to the liquid coating on the wall 111 and travel out of the reactor with the vapor phase species as a suspension. The solid products 105 leaving the reaction zone 104 at high temperature can move into the cooling top zone 106 with the cooler top liquid reservoir 107. The cooler reactant gases entering the pre-heater section 103 can remove heat and cool the reservoir 108. This lower reservoir 108 can be cross exchanged with the top reservoir 107 to cool the product stream 105. More than two reservoirs can be similarly configured for finer gradations of thermal integration. The gas/liquid flow regime can be maintained by controlling the linear velocity of gas, and the pressure applied to the liquid side, controlling rate of permeation of liquid through the wetted wall. In some applications, for example pyrolysis of hydrocarbons producing solid carbon products, together with the reactant hydrocarbons a feed of solid particulates 112 can be optionally co-fed with the reactants providing a solid scaffold 113 on which additional carbon can be deposited. Heat to the central reaction zone 104 can be added by one of a number of heating options including electrical (induction or resistance), gas fired heaters, or the use of a heat transfer media to convey heat through tubular heat transfer surfaces. The external liquid reservoir may also be circulated external to the main vessel interior.

In any of the embodiments described with respect to FIGS. 8A-9, the tubes and tube sheets can be constructed from a material that is stable within the reaction environment and may be solid (e.g., as a rolled or extruded material) with a smooth surface, or alternatively, the material surface may also be advantageously altered to a woven, mesh, or otherwise porous structure to facilitate wettability or specific applications. In some embodiments, the draft tube material can be made from tubes, sheets, woven wires, etc. of refractory materials including molybdenum, niobium, tantalum, tungsten, rhenium, alloys thereof, and/or combinations thereof. In some embodiments, the tube and tube sheet material can be made from tubes, sheets, woven wires, etc., of refractory metal-carbides or oxides of molybdenum, niobium, tantalum, tungsten, rhenium, alloys thereof, and/or combinations thereof. In some embodiments, the tube or tube sheet material can be made from tubes, sheets, woven wires, etc. of ceramic and ceramic-based composites containing: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, and graphite, with a surface coating of refractory materials including molybdenum, niobium, tantalum, tungsten, rhenium, alloys thereof, and/or metal-carbides or oxides to facilitate wettability or specific applications. In other embodiments, the tubes, sheets, woven wires, etc. can be made of composite materials with surface morphologies or structures that promote enhanced wetting. In other embodiments, the material can be formed in such a manner to control the internal porosity and permeability of the liquid by controlled the pore sizes and chemical composition of the internal surfaces. In some embodiments, the internal structures may be structured packing formed as geometric shapes including tubes, spheres, and irregularly shaped bodies of these materials. The internal structures may also be perforated plates and combinations of perforated plates and geometric shapes. In some embodiments, the liquid is a molten metal containing one or more elements including Ag, Au, Sb, Sn, Bi, Ni, Cu, Fe, Pt, In, Pb, Pd, Co, Te, Rh, Ga, oxides thereof, and/or mixtures thereof. In some embodiments, the molten media can comprise a molten salt, a molten metal, or any combination thereof. In some embodiments, the salt mixture comprises one or more oxidized atoms (M)₊ₘ and corresponding reduced atoms (X)₋₁, wherein Mis at least one of K, Na, Mg, Ca, Mn, Zn, Fe, La, or Li, and wherein X is at least one of F, Cl, Br, I, OH, SO₃, or NO₃. Exemplary salts can include, but are not limited to NaCl, NaBr, KCl, KBr, LiCl, LiBr, CaCl₂, MgCl₂, CaBr₂, MgBr₂ and combinations thereof. In yet another embodiment, the tube or tube sheet material can be prepared in-situ in the reactor by contacting the refractory metal directly with oxygen or carbon in a solid, gaseous, or dissolved state, which is in direct contact with the molten liquid.

In any of the embodiments described with respect to FIGS. 8A-9, the reactor can operate at suitable conditions for the desired reaction to occur. In some embodiments, the temperature can be selected to maintain the molten media in the molten state such that the molten media is above the melting point of the composition while being below the boiling point. In some embodiments, the system can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. In some embodiments, the temperature can be operated just above the solidification temperature of the wetted media layer, and periodically lowered below the transition temperature to promote separation of any settled solid particulates form the reaction surface. The reactor can operate at any suitable pressure. In some embodiments the reactor may operate at higher pressures with an appropriate selection of the reactor configuration, operating conditions, and flow schemes, where the pressure can be selected to maintain a gas phase holdup and superficial gas velocity within the reactor.

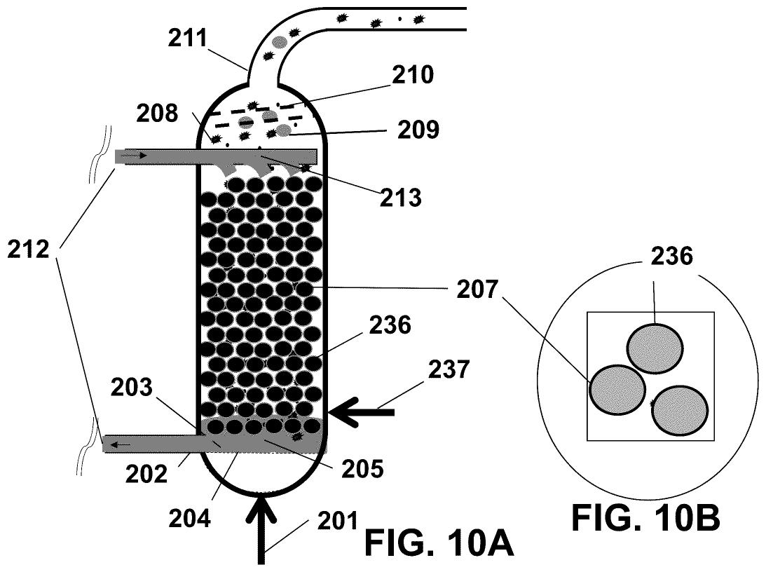

In another embodiment as shown in FIG. 10A and FIG. 10B, gas phase reactants 201 can be introduced into a reactor vessel or part of a reactor vessel 202 that can be partially filled with a liquid medium 203. The gas can pass through a distributor plate, nozzle or set of nozzles 204 and through a shallow pool of liquid media 203, which can preheat the gas stream 205 before passing into a packed bed 236. Alternatively, the gas can be introduced through an orifice 237 above the surface of the shallow pool of liquid media such that the gas phase remains continuous throughout. The gas can rise through the void spaces of the packed bed 236, contacting the down-coming liquid media 203 from the top of the reactor exchanging heat. The down-coming liquid media can coat the packing 236 and form a thin film 207 over the surface of the packing material 236. In this configuration, the liquid can be the discontinuous phase, and the gas can form a continuous phase within at least the reaction section. The reaction can proceed in the gas phase or on the surface of the liquid medium 203 and produces solid products 208, which are prevented from contacting the solid surface of the packing material 236 by the wetting layer of liquid 207 adhering to the solid surface. The reaction proceeds and the reaction products are passed through a separator such as a demister 210, which separates liquid droplets 209 entrained in the reaction products and returns the liquid media to the reactor. The reaction products leave the reactor through an exit 211. After exchanging heat with the incoming gas 201 to cool the liquid media and heat the incoming gas, the liquid media can be circulated out of the bottom of the reactor 202 and be returned to the top of the reactor 213 via an external circulation loop 212. Heat can be added or removed from the liquid medium 203 in the external circulation loop 212 using any suitable heat exchanger configurations. Heat may be added to the reactor electrically (induction or resistance) through heating elements or by passing current directly through the solid material selected for its resistivity (e.g. graphite, SiC, WC). The liquid media can be circulated by means of a pump or bubble lift.

Whereas FIG. 10A and FIG. 10B illustrate an implementation as a countercurrent trickle bed reactor, reactant gases may also be introduced in the top of the reactor to flow co-current to the down going liquid. The flow regime inside of the reactor can be controlled by manipulation of the liquid and gas flow rates and controlling the surface area or open area of the wetted packed bed.

In the embodiments of FIGS. 10A and 10B, the packing, and any tubes and tube sheets can be constructed from a material that is stable within the reaction environment and may solid (e.g., as a rolled or extruded material, milled, cast, etc.) with a smooth surface, or alternatively, the material surface may also be advantageously altered to a woven, mesh, textured, or otherwise porous structure to facilitate wettability or specific applications. In some embodiments, the packing and/or inlet and outlet tube material can be made from structured packing (rings, spheres, saddles, etc.), plates, unstructured packing, tubes, sheets, woven wires, etc. of refractory materials including molybdenum, niobium, tantalum, tungsten and/or rhenium and their alloys. In some embodiments, the packing, tube, and/or tube sheet material can be made from structured packing (rings, spheres, saddles, etc.), plates, unstructured packing, tubes, sheets, woven wires, etc., of refractory metal-carbides or oxides of molybdenum, niobium, tantalum, tungsten and/or rhenium and their alloys.

In some embodiments, the packing, tubes, and/or tube sheet material can be made from ceramic and ceramic-based composites containing: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, and graphite, with a surface coating of refractory materials including molybdenum, niobium, tantalum, tungsten and/or rhenium and their alloys, metal-carbides or oxides to facilitate wettability or specific applications. In other embodiments, the packing, tubes, sheets, woven wires, etc. can be made of composite materials with surface morphologies or structures that promote enhanced wetting. In some embodiments, the internal structures may be structured packing formed as geometric shapes including tubes, spheres, and irregularly shaped bodies of these materials. The internal structures may also be perforated plates and combinations of perforated plates and geometric shapes.

In some embodiments, the liquid can comprise a molten metal containing one or more elements including: Ag, Au, Sb, Sn, Bi, Ni, Cu, Fe, Pt, In, Pb, Pd, Co, Te, Rh, Ga, oxides thereof, and/or mixtures thereof. In some embodiments, the molten media can comprise a molten salt, a molten metal, or any combination thereof. In some embodiments, the molten salt mixture comprises one or more oxidized atoms (M)₊ₘ and corresponding reduced atoms (X)₋₁, wherein M is at least one of K, Na, Mg, Ca, Mn, Zn, Fe, La, or Li, and wherein X is at least one of F, Cl, Br, I, OH, SO₃, and/or NO₃. Exemplary salts can include, but are not limited to NaCl, NaBr, KCl, KBr, LiCl, LiBr, CaCl₂, MgCl₂, CaBr₂, MgBr₂, and combinations thereof. In yet another embodiment, the packing, tube, or tube sheet material can be prepared in-situ in the reactor by contacting the refractory metal directly with oxygen or carbon in a solid, gaseous, or dissolved state, which is in direct contact with the molten liquid.

In the embodiments of FIGS. 10A and 10B, the reactor can operate at suitable conditions for the desired reaction to occur. In some embodiments, the temperature can be selected to maintain the molten media in the molten state such that the molten media is above the melting point of the composition while being below the boiling point. In some embodiments, the system can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. In some embodiments, the temperature can be operated just above the solidification temperature of the wetted media layer, and periodically lowered below the transition temperature to promote separation of any settled solid particulates form the reaction surface. The reactor can operate at any suitable pressure. In some embodiments the reactor may operate at higher pressures with an appropriate selection of the reactor configuration, operating conditions, and flow schemes, where the pressure can be selected to maintain a gas phase holdup and superficial gas velocity within the reactor.

In some embodiments, the properties of fluidized solid bed reactors can be used to provide a transient renewable solid wall to prevent solid accumulation on the solid structural elements. This is similar to the use of a wetted wall that uses a liquid film to prevent direct contact between the reaction products and the solid wall, only the liquid film is replaced with a fluidized bed of solid material. The reaction products can then preferentially deposit on the fluidized bed material rather than the solid wall of the reactor vessel.

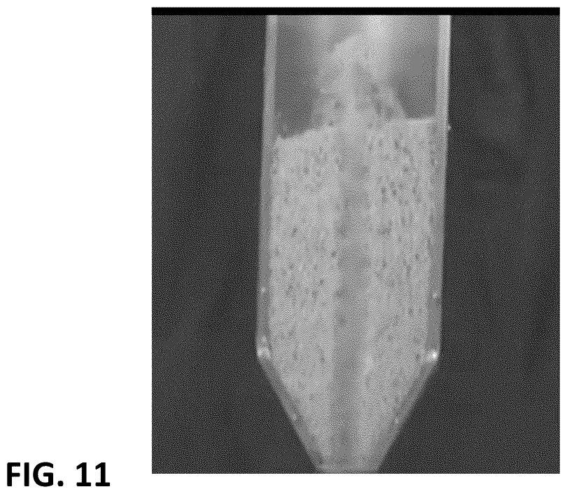

FIG. 11 shows gas passing through a bed filled with solid particulates commonly known as a spouting bed, specific particle properties make the stable gas channel possible with a fraction of the solid moving upward with the gas, deposited at the bed surface, and circulating downward again. The nature of the circulation caused different size particles to stratify differently allowing a size range to be selectively removed.

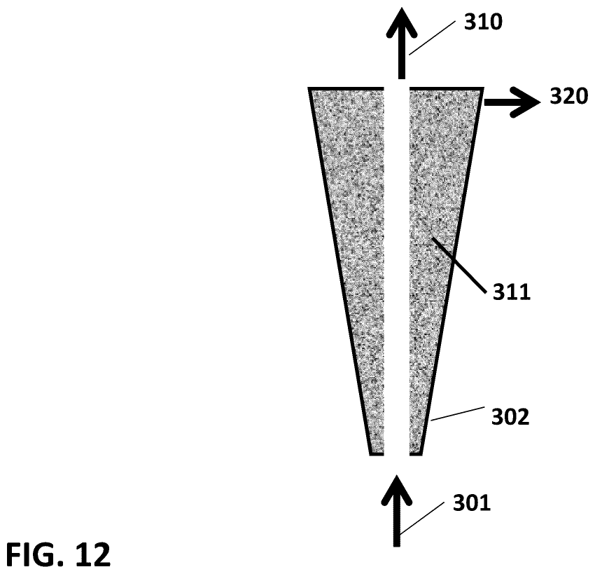

FIG. 12 shows schematically a tapered bed with a gas channel for the reactant gases flowing up the center of the column reactor 302, which is packed with solid particulates 311. The gas 301 can enter through a lower portion of the tapered bed and form the gas channel through the solid particulates 311. Gas 310 (and some entrained particles) may exit the top of the reactor 302. Solids may also be removed from the top or other zones of the bed through a solids outlet 320. While shown as being placed at the top of the solids bed, the solids outlet 320 can be positioned anywhere along the tapered bed to remove the desired size fraction of the solids. In some aspects, a plurality of solids outlets 320 may be positioned along the tapered bed to allow different amounts of the solids to be removed as the solids grow in size. In some aspects, solid carbon can be produced from hydrocarbon pyrolysis in a heated bed filled with solid particles (e.g., sand, solid carbon, etc.), the reaction can occur predominately in the center channel where the reactant gases are most concentrated. Because there is some diffusion/percolation of the gases into the solid bed there will be additional carbon deposition on the particles forming the wall of the solids bed, causing growth of the bed and the particle sizes. When the bed is densely packed little bulk flow away from the central cavity occurs relative to the flow in the main channel.

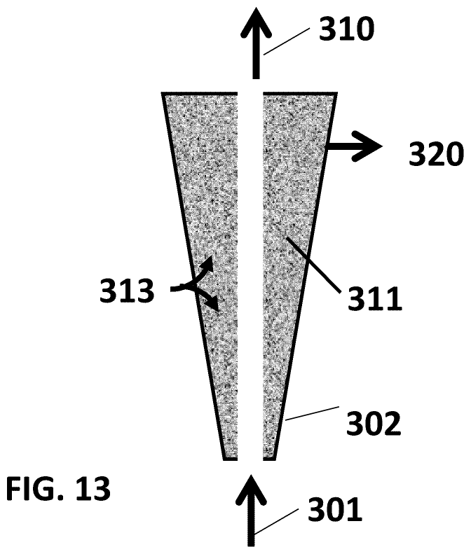

In some embodiments as shown in FIG. 13, additional gases in stream 313, reactive or nonreactive, can be optionally introduced through the outer solid wall and caused to flow primarily along the outer wall to prevent reaction on the wall. For example, one or more gas inlets or perforations can be used as a gas inlet on the outer wall, and/or the outer wall can be formed of a gas permeable material to allow gas to permeate through the wall. The gas can serve to prevent contact of the feed gases and/or reaction products with the outer wall to prevent deposition of any reaction products on the outer wall. In the example of hydrocarbon pyrolysis this shield gas can be hydrogen.

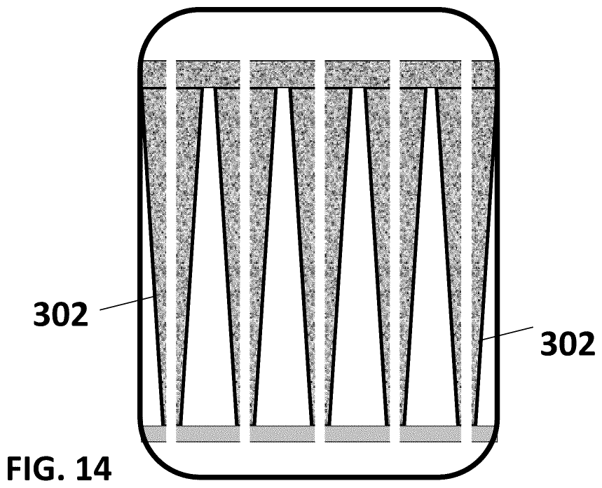

Solid particulate wall reactors 302 can be configured in arrays as shown in FIG. 14 whereby heating through a combustion or electrical heater can heat the tubes containing the solids. In the case of high thermally conductive solids (including carbon) heat can be transferred through the wall and the solid particles. The remaining reactor configurations can be similar to or the same as those described with respect to FIGS. 11-13.

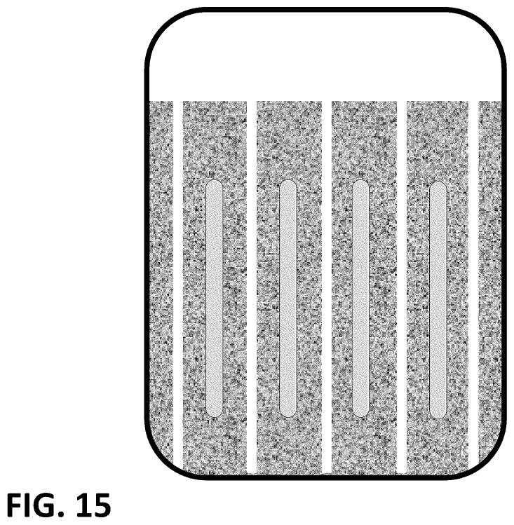

In some embodiments as shown schematically in FIG. 15, a large bed of particulate solids can have immersed heating elements (including combustion, electrical, or heat transfer fluid units) within the bed in direct thermal contact. The elements may be bathed in an inert gas (or in the case of pyrolysis, hydrogen, etc.) to prevent solid deposition on the heating elements. A large number of gas inlets at the bottom of the reactor allow many reaction channels to form around the heating elements. The gas inlets can be arranged and configured to form a desired array of reaction channels to form in the bed of particulate solids.

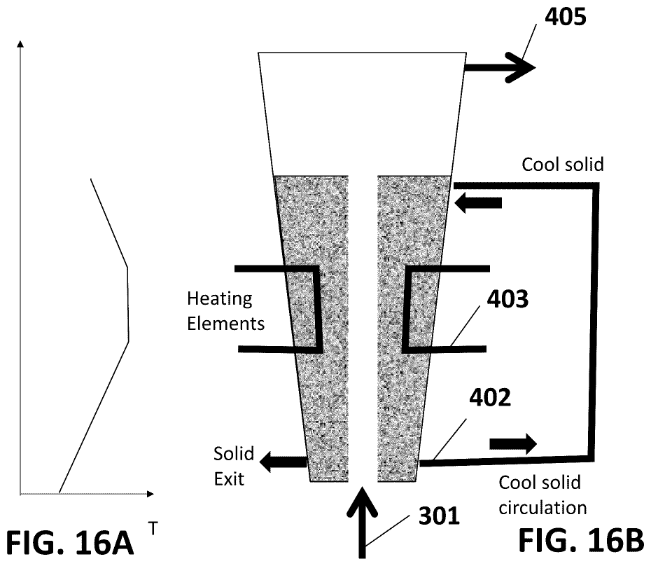

In some embodiments as shown schematically in FIG. 16B, the particulates in the particulate bed can circulate from the top to the bottom using the particulate recirculation loop 402. The inlet reactant gases 301 can pass upwards through the particulates and cool the solid particulates at the bottom of the bed, where the particulates can be removed and a portion carried to the top of the bed through the recirculation loop 402. The upwardly channeling gas can pass into the central region of the bed and be heated with combustion gases, electrically, and/or with a heat transfer fluid in a heating element 403, which can cause the reaction to occur and produce solid products that continue upwards in the channel. The product gases can leave as stream 405. The cooler solids at the top of the reactor can move downward and be heated by the hot rising gases, which can cool the gas. In this manner, the reactor can be heat integrated using the exiting gases to heat the downward traveling solids, and the entering reactant gases can be heated by the downward moving solids.

In embodiments having a solid wetted by liquids, the selection and preparation of materials that satisfy structural requirements of the reaction system and are able to be wetted by a liquid film can be important. For example, the tubes, tube sheets, woven wires, perforated plates, packings, or other geometric shapes and their combinations referenced in the embodiments disclosed herein can be synthesized as refractory metals, such as molybdenum, niobium, tantalum, tungsten and/or rhenium and their alloys, or their carbides, oxides and their alloys, or composite materials deposited on other structural materials. In some embodiments, it is favorable to control the bulk or composite material porosity to facilitate or enhance the permeability of the material to the liquid media. In other embodiments, it is favorable to control the surface structures and morphology to promote and enhance wetting phenomena, and to reduce or minimize gas and liquid permeability.

In some embodiments, a surface coating of refractory metals such as molybdenum, niobium, tantalum, tungsten and/or rhenium and their alloys or their corresponding metallic-carbides can be deposited onto a substrate to form a layer that can be wetted with the liquid. In some embodiments, the substrate can be a structural metal such as a metal used to form a reactor. In some embodiments, the substrate can comprise structural materials of ceramic and ceramic-based composites containing: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, and graphite, and/or high nickel alloys (e.g., Monel, Hastelloy, Haynes, etc.) using chemical vapor deposition. In some embodiments, a refractory metal halide (e.g., WF₆, (MoCl₅)₂, TaCl₅, NbCl₅, ReCl₅) or carbonyl (e.g., W(CO)₆, Mo(CO)₆, Ta(CO)₆, Re₂(CO)₁₀, Nb₂(CO)₁₂) can be reduced in a high vacuum chamber using CH₄ or H₂ as a reductant to directly deposit W, Mo, Ta, Nb or Re, and/or their corresponding carbide onto the substrate material surface.

For the vapor deposition process, the deposition temperature can be operated at a temperature above about 400° C., above about 500° C., above about 600° C., or above about 800° C. In some embodiments, the deposition temperature can be operated at a temperature below about 1,500° C., below about 1,400° C., below about 1,300° C., below about 1,200° C., below about 1,100° C., or below about 1,000°° C. In some embodiments, the reduction temperature can be selected to control the degree of tensile and compressive forces between the deposited refractory metal or the refractor metal's carbide and the substrate being deposited onto during thermal cycling. In some embodiments, the deposited film thickness can be above about 1 micrometer, above about 10 micrometers, or above about 50 micrometers. In some embodiments, the deposited layer can be less than about 200 micrometers, less than about 100 micrometers, or less than about 75 micrometers.

The composite layers of multiple refractory metals or their carbides can be used to further control tensile and compressive forces introduced by mismatches in the coefficient of thermal expansion between the substrate and deposited layer. Each layer in composite material can have thicknesses above about 1 micron, above about 10 micrometers, or above about 50 micrometers. In some embodiments, each layer in the composite material can have thicknesses less than about 200 micrometers, less than about 100 micrometers, or less than about 75 micrometers.

In some embodiments, the substrate and deposited layer can be selected to facilitate an interfacial reaction to enhance the surface layer adhesion to the substrate layer. Specific examples can include, but are not limited to, the reaction of W, Mo, Nb or Ta with graphite or high nickel alloys to form corresponding carbides or metal alloys at the interface. In another embodiment, the substrate material is selected to have an appropriate coefficient of thermal expansion that reduces or minimizes the mismatch and thus compressive or tensile stresses at the interface with the deposited material. In some embodiments, the substrate coefficient of thermal expansion can be between about 2×10⁻⁶ m/m-K and about 4×10⁻⁶ m/m-K, or between about 1×10⁻⁶ m/m-K and about 5×10⁻⁶ m/m-K, or between about 3×10⁻⁶ m/m-K and about 7×10⁻⁶ m/m-K. In some embodiments, the structural material substrate surface morphology can be controlled to a specific roughness to promote mechanical interlocking of the deposited layer and promote adhesion.

In some embodiments, a surface coating of a refractory metal of molybdenum, niobium, tantalum, tungsten and/or rhenium, their alloys or carbides can be deposited onto structural materials of ceramic and ceramic-based composites containing: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, and/or high nickel alloys (e.g., Monel, Hastelloy, Haynes) using plasma-spray deposition. In some embodiments, the substrate deposition temperature can be operated at a substrate temperature above about 400° C., above about 500° C., above about 600° C., or above about 800° C. In some embodiments, the substrate deposition temperature can be operated at a temperature below about 1,500° C., below about 1,400° C., below about 1,300° C., below about 1,200° C., below about 1,100° C., or below about 1,000° C. In some embodiments the substrate temperature during plasma-spray coating can be selected to control the degree of tensile and compressive forces between the deposited refractory metal, the substrate's carbide or oxide and the substrate being deposited onto during subsequent thermal cycling. In some embodiments, the deposited film thickness can be above about 1 micrometer, above about 10 micrometers, or above about 50 micrometers. In some embodiments, the deposited layer can be less than about 200 micrometers, less than about 100 micrometers, or less than about 75 micrometers. In some embodiments, the structural material porosity and surface roughness can be controlled to promote adhesion of the deposited layer onto the substrate, enhancing adhesion and the ability for a wetted liquid to permeate through the substrate material. In another embodiment, the substrate material can be selected to have an appropriate coefficient of thermal expansion that reduces or minimizes the mismatch and thus compressive or tensile stresses at the interface with the deposited material. In some embodiments, the substrate coefficient of thermal expansion can be between about 2×10⁻⁶ m/m-K and about 4×10⁻⁶ m/m-K, or between about 1×10⁻⁶ m/m-K and about 5×10⁻⁶ m/m-K, or between about 3×10⁻⁶ m/m-K and about 7×10⁻⁶ m/m-K. In some embodiments, the substrate and deposited layer can be selected to facilitate an interfacial reaction to enhance the surface layer adhesion to the substrate layer. Specific examples can include, but are not limited to, the reaction of W, Mo, Nb or Ta with graphite or high nickel alloys to form corresponding carbides or metal alloys at the interface.

In some embodiments, a surface coating or internal pore coating of refractory metal oxides of molybdenum, niobium, tantalum, tungsten and/or rhenium and their alloys are deposited onto structural materials of ceramic and ceramic-based composites comprising: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, and/or high nickel alloys (e.g., Monel, Hastelloy, Haynes) using electrochemical deposition. The electrochemical deposition can take place in a three-electrode cell. In some aspects, the cell can be agitated or have a circulating fluid. In some aspects, electrodes can comprise the structural material, platinum, and silver/silver chloride as the working, counter, and reference electrodes, respectively. The refractory metal can be reacted with hydrogen peroxide to form an aqueous refectory metal oxide solution which functions as the deposition electrolytes. In some embodiments, molybdic acid, niobic acid, tantalic acid, peroxotungstic acid, and/or perrhenic (VII) acid can be used to deposit the refractory metal oxide, though any suitable acid capable of forming a solution with the refractor metal oxide can be used. The refractory metal oxide (e.g., MoO₃, Nb₂O₅, Ta₂O₅, WO₃, ReO₃) can be further reduced in a high temperature chamber using CH₄ or H₂ as a reductant to directly deposit reduced W, Mo, Nb, Ta, or Re, or their corresponding carbides onto the substrate material surface. In some embodiments, the aqueous deposition voltage can be operated below about −1 volts, below about −0.8 volts, below about −0.6 volts, or below about −0.4 volts. In some embodiments the current density can be operated below about 3 mA/cm², below about 2 mA/cm² or below about 1 mA/cm². In some embodiments, refractory metals (Mo, Nb, Ta, W, Rh, etc.) can be directly deposited on the substrates by molten salt electrochemical deposition. using refractory metal salts (e.g., MoCl₃, NbCl₅, K₂TaF₇, Na₂WO₄, ReCl₃, etc.) dissolved in alkali salts such as alkali chloride salts. In some aspects, the structural material can act as the working electrode, tungsten can act as the counter electrode, and platinum can act as the reference electrode. In some embodiments, the molten salt electrochemical deposition current densities can be below 30 mA/cm², below about, 20 mA/cm², or below about 10 mA/cm². In some embodiments, the deposition temperature can be operated at about the salt mixture's melting point, about 100° C. above the salt's melting point, or about 200° C. above the salt's melting point. In some embodiments, the deposition voltage can be selected to change the structure of the deposited refractory metal or the refractory metal's carbide. In some embodiments, the reactor reduction step can be operated at a temperature below about 1,500° C., below about 1,400° C., below about 1,300° C., below about 1,200° C., below about 1,100° C., or below about 1,000° C. In some embodiments, the reduction temperature can be selected to control the degree of tensile and compressive forces between the deposited refractory metal or the refractory metal's carbide and the substrate being deposited onto during thermal cycling. In some embodiments, the deposited film thickness can be above about 1 micrometer, above about 10 micrometers, or above about 50 micrometers. In some embodiments, the deposited layer can be less than about 200 micrometers, less than about 100 micrometers, or less than about 75 micrometers. In some embodiments, the structural material porosity can be controlled to promote penetration of the deposited layer into the substrate, enhancing adhesion and the ability for a wetted liquid to permeate through the substrate material. In another embodiment, the substrate material is selected to have an appropriate coefficient of thermal expansion that minimizes the mismatch and thus compressive or tensile stresses at the interface with the deposited material. In some embodiments, the substrate coefficient of thermal expansion can be between about 2×10⁻⁶ m/m-K and about 4×10⁻⁶ m/m-K, or between about 1×10⁻⁶ m/m-K and about 5×10⁻⁶ m/m-K, or between about 3×10⁻⁶ m/m-K and about 7×10⁻⁶ m/m-K. In yet another embodiment, the substrate and deposited layer can be selected to facilitate an interfacial reaction to enhance the surface layer adhesion to the substrate layer. Specific examples could include, but are not limited to, the reaction of W, Mo, Nb or Ta with graphite or high nickel alloys to form corresponding carbides or metal alloys at the interface.

In another embodiment, a surface coating or internal pore coating of refractory metal salts or oxides of molybdenum, niobium, tantalum, tungsten, rhenium, and/or their alloys can be deposited onto structural materials of ceramic and ceramic-based composites containing: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, and/or high nickel alloys (e.g., Monel, Hastelloy, Haynes, etc.) using wet impregnation. A refractory metal salt can be used as a precursor in a solution containing the salt, a solvent, and a hydroxycarboxylic acid, which together from a chelate that can be crosslinked to form a sol-gel through esterification when a polyalcohol is introduced. The structural material is then coated with this sol-gel through methods that can include submersion and evaporation, dip-coating, spraying, etc. to deposit the refractory metal salt or metal oxide on the surface. Using the sol-gel to coat the structural material allows for uniform layers to be deposited which, after heat treatments (e.g., calcining) and optionally reductions (e.g., with hydrogen, etc.), can form porous structures with high surface area and channels that promote the wetting of the coating by the liquid metal. The structural material can then be coated with this solution through methods that can include submersion and evaporation, dip-coating, spraying, etc. to deposit the refractory metal salt or metal oxide on the surface. The deposition temperature can be varied in the range in which the solution is stable as a liquid.

In some embodiments, the structural material may have high porosity to allow the coating solution to be absorbed into the material, coating it with the refractory metal to make the internal surfaces wettable by the liquid media. This design can enhance the flow of the molten media through the pores of the structural material under modest pressures. In other embodiments, the structural material may have very low porosity to prevent the diffusion of gases through the reactor wall. A layered approach could also be implemented for both types of structural materials to achieve a wetted wall reactor that is gas impermeable. Once the refractory metal salt or oxide has been deposited, heat treatments can be implemented in oxidative, reductive, or carburizing environments to convert the deposited coating and achieve the desired metal oxide, metal, or metal-carbide. These heat treatments can be done at a temperature above about 300° C., above about 400° C., above about 500° C., above about 600° C., above about 700° C., above about 800° C., above about 900° C., above about 1000° C., above about 1100° C., or above about 1200° C. In another embodiment, the treatment temperature can be selected to control the degree of tensile and compressive forces between the deposited refractory metal, its oxide, or its carbide and the substrate being deposited onto during thermal cycling. In another embodiment, the substrate material can be selected to have an appropriate coefficient of thermal expansion that minimizes the mismatch and thus compressive or tensile stresses at the interface with the deposited material. In some embodiments, the substrate coefficient of thermal expansion can be between about 2×10⁻⁶ m/m-K and about 4×10⁻⁶ m/m-K, or between about 1×10⁻⁶ m/m-K and about 5×10⁻⁶ m/m-K, or between about 3×10⁻⁶ m/m-K and about 7×10⁻⁶ m/m-K. In some embodiments, the deposited film thickness, controlled by the number of coating layers applied, can be above about 1 micrometer, above about 10 micrometers, or above about 50 micrometers. In some embodiments, the deposited layer can be less than about 200 micrometers, less than about 100 micrometers, or less than about 75 micrometers. In some embodiments, the substrate and deposited layer can be selected to facilitate an interfacial reaction to enhance the surface layer adhesion to the substrate layer. Examples could include but are not limited to, the reaction of W, Mo, Nb or Ta with graphite or high nickel alloys to form corresponding carbides or metal alloys at the interface. In other specific embodiments, the structural material substrate surface morphology can be controlled to a specific roughness to promote mechanical interlocking of the deposited layer and promote adhesion.

The surface preparation techniques as described herein can have the final surface preparation of the reactor materials or internal wetted-solid surfaces prepared ex-situ in a separate reactor by subsequent oxidation, reduction or carburization using O₂, H₂O, H₂, and/or CH₄ (e.g., in a concentration of 0.1-10 vol %, diluted in H₂ or inert, etc. to control the reaction process), or in-situ by contacting the reduced refractory metal, oxide or carbide with a reactive species, either in solution in a stable state at the operating temperature and pressure of the molten media, introduced in the molten liquid, or in the gas phase prior to contact with the molten media. In some embodiments, the wetted surface can be prepared by indirect contact of the reactive species with the surface in the presence of the molten media.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Wetted Wall Tubular Reactor

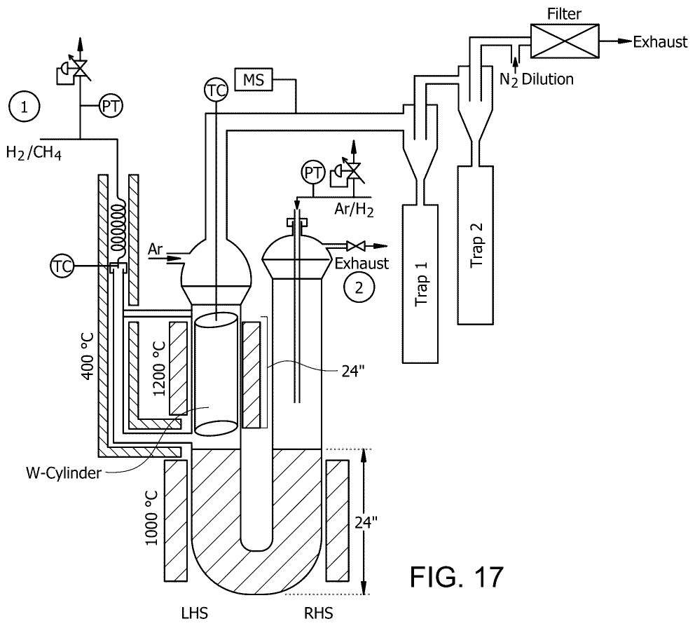

In a specific example, a molten Sn wetted layer on the internal surfaces of a tungsten cylinder reactor has been prepared by a specific set of preparation conditions. As seen in FIG. 17, a 0.002″ thick W-foil, rolled into a cylinder was inserted inside a quartz reactor serving as a primary containment vessel. The bottom half of the reactor “U-tube” was filled with molten Sn. The reactor was purged with H₂ in Ar and heated to 700° C., where two lances were submerged to bubble H₂ through both sides of the liquid media to reduce any metal oxides in the media. The off-gases were measured to determine when the reduction step was completed and the lances removed. The reactor was subsequently heated to 1000° C. and the outlet side of the right-hand-side of the reactor closed, leading to pressurization of the right side of the U-tube and raising the liquid of the left-hand side to completely submerge the W-foil in molten Sn. Pure CH₄ was subsequently introduced through the left-hand-side inlet below the W-foil and bubbles allowed to rise through the center of the W-cylinder submerged below the liquid Sn level for 24 hours at 1000° C. The pressure on the right-hand-side was maintained to keep the liquid level raised on the left-hand-side of the reactor. The gas fed to the left-hand-side of the reactor was switched to H₂ diluted in Ar and the pressure on the right-hand-side of the reactor was subsequently lowered to recede the liquid below the left-hand-side reactor inlet.

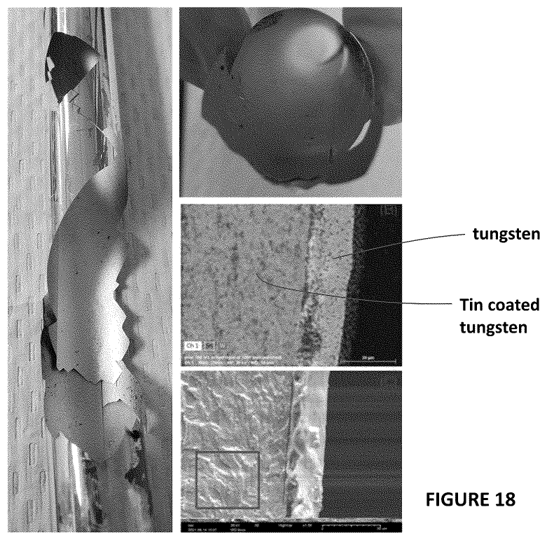

In FIG. 18, a cross-section and images of the W-foil post-recession of the liquid Sn is shown, indicating a clear Sn layer coating the entire internal surface of the W-cylinder. The experiment was performed multiple times for active controls and testing linear velocities through the reactor. In this specific example, the reactor was reheated to 1200° C. post liquid recession and CH₄ gas was reintroduced to the side inlet arm on the left-hand-side of the reactor at a specified flowrate to cause linear velocity greater than 10 m/s but less than the critical linear velocity where gas-shear on the liquid surface removes the protective media layer within the W-cylinder. Carbon produced from the reactor was conveyed by the high-linear velocities from the reactor to downstream cyclones and a filter for separation. The use of a U-tube in this specific example facilitates the ability to re-submerge the W-cylinder in molten media at any operating condition by freeboard pressurization of the right-hand-side of the reactor. Other configurations of reintroducing molten media to the surface of the W-cylinder are easily configurable to those skilled in the art with the benefit of this disclosure.

### Example 2

### Packed Bed Reactor with Molten Metal

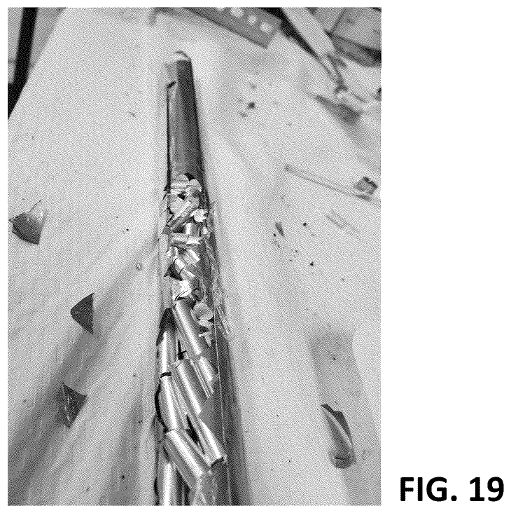

In a specific example, a molten Sn wetted layer on the internal surfaces of a tungsten cylinder reactor filled with W-packing has been prepared by a specific set of preparation conditions. As seen in FIG. 19, a 0.002″ thick W-foil, rolled into a cylinder was inserted inside a quartz reactor serving as a primary containment vessel. The reactor was packed with 3 mm diameter cylindrical tungsten packing 5-10 mm in length throughout the reactor. Solid shots of Sn were added to the reactor and the system was purged with H₂ in Ar and heated to 700° C. H₂ was bubbled through the liquid media to reduce any metal oxides in the media. The gas inlet was at the base of the reactor to remove the need for a non-wetting lance from the top of the reactor. The off gases were measured to determined when the reduction step was completed. The reactor was subsequently heated to 1200° C. Pure CH₄ was introduced through the base of the reactor below the W-foil and packing cylinders and bubbles allowed to rise through the center of the W-cylinder submerged below the liquid Sn level for 24 hours at 1200° C. Methane conversion was approximately 80%. Carbon produced was conveyed from the reactor using an ancillary inert flush gas and separated using cyclones and a gas filter. Upon removal from the reactor, as seen in FIG. 19, the tungsten is observed to be wetted with tin and no carbon is observed to have been deposited. The use of a packed bed in this specific example facilitates containment of the liquid media without the need for circulation of the fluid. Other configurations such a trickle bed created by circulating the media and reintroducing it at the top are easily configurable to those skilled in the art with the benefit of this disclosure.

### Example 3

### Tubular Reactor Coated with Molten Salt

In another specific example similar to FIG. 2, a quartz tubular reactor 200 mm in length and 10 mm in diameter was wetted by contact with molten CaCl₂ at 1000° C. The temperature was increased to 1100° C. and methane preheated to 550° C. and latm pressure was introduced at a flow rate to maintain a velocity of 0.5 m/s in the reactor. The gas phase reaction products of the decomposition were monitored by mass spectroscopy and consisted primarily of hydrogen. After approximately 3 hours of operation the feed gas was modified to argon and the reactor cooled. Inspection of the reactor showed no significant accumulation of carbon on the reactor walls with an observable salt coating remaining on the quartz.

### Example 4

### Trickle Packed Bed Reactor with Molten Salt

In another specific example similar to FIG. 10A, a 1-inch diameter quartz tubular reactor 24 inches in length was packed with ⅛ inch diameter spherical quartz beads. Argon was introduced at the bottom of the reactor at 100 sccm and 1 atm of pressure and bubbled through a 1-inch pool of molten CaCl₂ at 1200° C. at the bottom of the reactor. After bubbling the molten salt was dispersed throughout the reactor and wetted the beads within the reactor. The feed gas was then changed to methane at 100 sccm and carbon particulates observed to be suspended in the reactor outlet. The gas phase reaction products of the decomposition were monitored by mass spectroscopy and consisted primarily of hydrogen. The reactor was operated continuously for approximately 90 minutes. The feed gas was changed to 100 sccm of argon and the reactor cooled. Inspection of the reactor showed no significant accumulation of carbon inside the reactor bed or on the salt covered beads. The quartz beads were observed to retain a salt coating.

### Example 5

### Electrodeposition

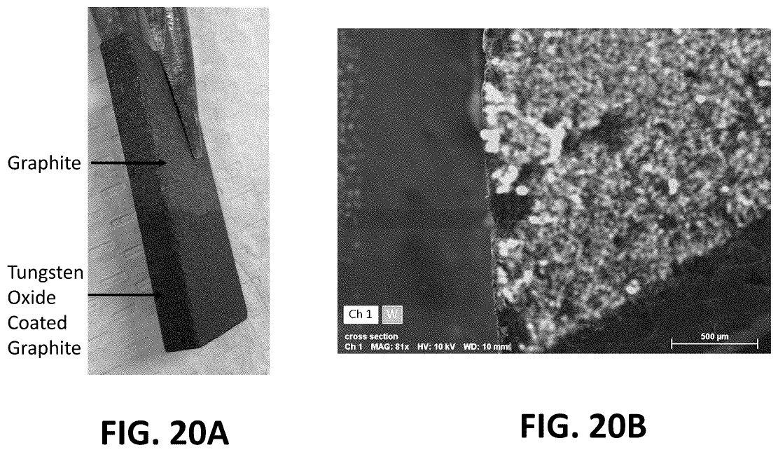

In another specific example, electrochemical deposition of WO₃ onto a highly porous, low coefficient of thermal expansion graphite (<3.5×10⁻⁶ m/m-K) was performed in an agitated three-electrode cell (graphite working electrode, platinum counter electrode, and Ag/AgCl reference electrode) at room temperature. The electrochemical deposition occurred at an applied voltage of −0.45 V with respect to the reference electrode, and a current density of 1 mA/cm². The deposition occurred for one hour using a peroxotungstic acid (PTA) solution. The PTA solution was synthesized by reacting 12-micron tungsten powder with 30% hydrogen peroxide at 60° C. in an agitated CSTR (700 rpm). Once the dissolution of tungsten was complete, the excess hydrogen peroxide was reacted with platinum supported on activated charcoal at room temperature until gas evolution ceased. The platinum catalyst was filtered, and the resultant PTA was diluted to a 50 mM tungsten concentration with a 1:1 mixture of DI water and 2-propanol. The deposited tungsten oxide on graphite was dried in a vacuum oven at 110° C. for an hour. FIG. 20A, shows the high porosity graphite coated with tungsten oxide which can be seen by the difference in color between the top and bottom of the sample. Elemental mapping of the cross section as shown in FIG. 20B shows tungsten oxide dispersed throughout. It should be noted, oxygen was omitted in the elemental mapping to highlight tungsten.

### Example 6

### Wet Impregnation

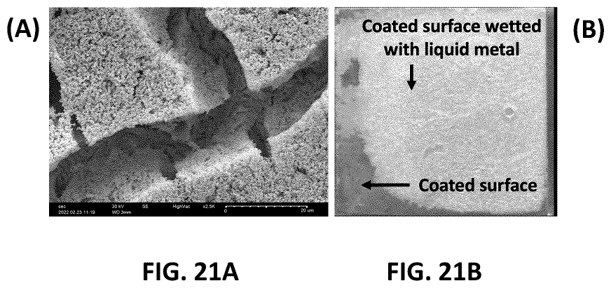

In another specific example, a tungsten carbide surface that was completely wetted by molten Sn was synthesized over a porous graphite substrate by wet impregnation. A 0.1 M solution of ammonium metatungstate in deionized water was mixed while stirring with citric acid to produce a chelate. Ethylene glycol was then introduced to form cross links through esterification and a sol-gel was formed. A coupon of extruded porous graphite with approximately 20% porosity was submerged in a beaker containing 50 mL of this solution and the beaker was placed on a hot plate for a few hours to raise the temperature to approximately 60° C. The water evaporated and a film of the W sol-gel was left behind. The coated graphite was placed in a drying oven at 110° C. overnight to remove any leftover moisture and then treated at 500° C. in Ar for 3 hrs. to calcine the gel, resulting in a tungsten oxide layer over the graphite. After a 24 hour treatment of the graphite at 1000° C. under H₂, the tungsten was reduced to a metallic state and the graphite reacted with it to form the tungsten carbide layer at the surface. At this stage, the surface was highly structured and had micro-channels all over the surface (FIG. 21A) which helped promote the complete wetting of this surface with the molten Sn because of the very high effective surface area and capillary pressures drawing the media into the pores. To test for wetting, a previously reduced droplet of molten Sn was introduced to the new tungsten carbide surface at 800° C. in a sessile drop experimental apparatus and the drop immediately spread over the surface, as seen in FIG. 21B.

### Example 7

### Chemical Vapor Deposition Sample

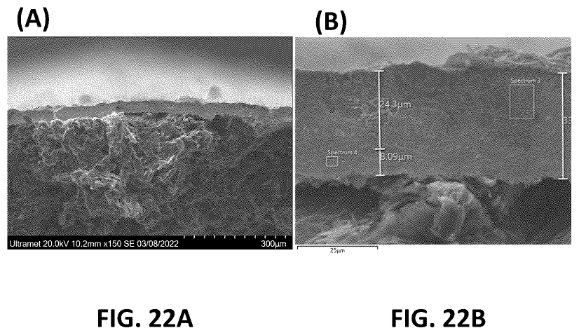

In another specific example, a surface roughened (200 grit sandpaper), porous graphite substrate with a coefficient of thermal expansion of approximately 3×10⁻⁶ m/m-K was coated in a ˜30 micrometer thick layer of W using chemical vapor deposition at approximately 600° C. The sample was subsequently heat treated to a temperature >1000° C. but <1600° C. under a 15:1 H₂:CH₄ gas atmosphere to convert the W layer to WC. The cross-section of the sample is shown in FIG. 22A, showing strong adhesion to the surface of the graphite with no delamination. In another specific sample shown in FIG. 22B, the same preparation procedure was followed, but the heat treatment was performed at a temperature >1000° C. but <1300° C. under pure CH₄ in a molten Sn bubble column. The cross-section of the sample post-acid leaching to remove the liquid media layer is shown in FIG. 22B, showing no delamination.

Having described various systems, processes, and materials herein, certain aspect can include, but are not limited to:

In a first aspect, a reactor comprises: a reactor vessel; a liquid film in contact with and coating at least a portion of a surface of an interior of the reactor vessel; and one or more reaction products in contact with the liquid film within the reactor vessel, wherein the liquid film is configured to wet at least a portion of the surface of the interior of the reactor vessel, and wherein the liquid film is formed from a material that inhibits the deposition of at least one reaction product of the one or more reaction products on the surface of the interior of the reactor vessel.

A second aspect can include the reactor of the first aspect, wherein the reactor comprises a tubular reactor vessel.

A third aspect can include the reactor of the first or second aspect, further comprising a heater.

A fourth aspect can include the reactor of the third aspect, wherein the heater is configured to heat the reactor vessel from an exterior of the reactor vessel.

A fifth aspect can include the reactor of the third aspect, wherein the heater comprises one or more electrical contacts in contact with a wall of the reactor vessel, wherein the heater is configured to heat the reactor vessel using resistive heating, induction heating, or a combination thereof.

A sixth aspect can include the reactor of the first aspect, wherein the reactor vessel comprises: a liquid pool in a lower portion of the reactor vessel, where the liquid pool comprises a portion of the material; an array of tubes disposed within the reactor vessel, wherein a lower end of each tube of the array of tubes is disposed below an upper level of the material in the liquid pool, and wherein the liquid film is in contact with an interior surface of each tube of the array of tubes; and a plurality of nozzles, where each nozzle of the plurality of nozzles is associated with each tube of the array of tubes, and wherein each nozzle is configured to receive a feed gas and pass the feed gas through the material in the liquid pool before passing the feed gas into each tube of the array of tubes.

A seventh aspect can include the reactor of the sixth aspect, further comprising: a tray, wherein an upper end of each tube of the plurality of tubes passes through the tray, wherein the tray is configured to direct the material passing through each tube to a circulation loop; and the circulation loop, wherein the circulation loop is configured to pass the material from the tray to the liquid pool.

An eighth aspect can include the reactor of the sixth or seventh aspect, further comprising: a heating fluid in contact with an exterior of the array of tubes.

A ninth aspect can include the reactor of the first aspect, wherein the reactor vessel comprises one or more tubular reactors, wherein the reactor further comprises: a liquid reservoir, wherein the liquid reservoir is configured to retain at least a portion of the material; and one or more injector nozzles in fluid communication with the liquid reservoir, wherein the one or more injector nozzles are configured to inject the material into each corresponding tubular reactor of the one or more tubular reactors.

A tenth aspect can include the reactor of the ninth aspect, further comprising: a first section of the one or more tubular reactors; a heater configured to heat the first section of the one or more tubular reactors; a second section of the one or more tubular reactors; and a heat exchanger configured to cool the second section of the one or more tubular reactors, wherein the first section is disposed between the one or more injector nozzles and the second section.

An eleventh aspect can include the reactor of the ninth or tenth aspect, further comprising: a disengagement section of the one or more tubular reactors, wherein the disengagement section comprises a disengagement pool, wherein the disengagement section is configured to pass a product stream over the disengagement pool and capture at least a portion of the material in the product stream in the disengagement pool.

A twelfth aspect can include the reactor of the first aspect, wherein the reactor vessel contains one or more reactor tubes, wherein the one or more reactor tubes are formed from a porous material, wherein the reactor further comprises: a liquid reservoir comprising the material disposed within the reactor vessel, wherein the material is in contact with an exterior of the one or more reactor tubes, wherein the one or more reactor tubes are configured to pass a portion of the material through a wall of the one or more reactor tubes to wet an interior surface of the one or more reactor tubes.

A thirteenth aspect can include the reactor of the twelfth aspect, further comprising: a heater configured to heat the material in the liquid reservoir.

A fourteenth aspect can include the reactor of the twelfth aspect, further comprising: a central reaction zone, wherein the liquid reservoir is disposed in the central reaction zone; a heater configured to heat the material in the central reaction zone; a preheat zone, wherein the preheat zone comprises a liquid in contact with a lower portion of the one or more tubular reactors; a cooling zone, wherein the cooling zone comprises the liquid in contact with an upper portion of the one or more tubular reactors; and a circulation loop fluidly connecting the preheat zone to the cooling zone, wherein the liquid is configured to circulate between the preheat zone and the cooling zone in a loop.

A fifteenth aspect can include the reactor of the first aspect, further comprising: a packing material disposed within the reactor vessel; a material inlet disposed above the packing material in the reactor vessel; and a material outlet disposed in a lower portion of the reactor vessel, wherein the material inlet is configured to introduce the material onto the packing material within the reactor vessel and form the liquid film over at least a portion of the packing material.

A sixteenth aspect can include the reactor of the fifteenth aspect, further comprising: a gas inlet disposed below the packing material and configured to introduce a feed gas into the reactor vessel through a layer of the material.

A seventeenth aspect can include the reactor of the sixteenth aspect, wherein the feed gas is a continuous phase within the reactor vessel.

An eighteenth aspect can include the reactor of the sixteenth or seventeenth aspect, further comprising: a demister disposed above the material inlet, wherein the demister is configured to remove at least a portion of the material from a product stream leaving the reactor vessel.

A nineteenth aspect can include the reactor of any one of the sixteenth to eighteenth aspects, further comprising: a heater, wherein the heater is configured to maintain a temperature within the reactor vessel.

A twentieth aspect can include the reactor of any one of the first to nineteenth aspects, wherein the material comprises a molten metal.

A twenty first aspect can include the reactor of the twentieth aspect, wherein the molten metal comprises Ag, Au, Sb, Sn, Bi, Ni, Cu, Fe, Pt, In, Pb, Pd, Co, Te, Rh, Ga, oxides thereof, and/or mixtures thereof.

A twenty second aspect can include the reactor of any one of the first to twenty first aspects, wherein the material comprises a molten salt.

A twenty third aspect can include the reactor of the twenty second aspect, wherein the molten salt comprises one or more oxidized atoms (M)^{+m} and corresponding reduced atoms (X)⁻¹, wherein M comprises at least one of K, Na, Mg, Ca, Mn, Zn, Fe, La, or Li, and wherein X comprises at least one of F, Cl, Br, I, OH, SO₃, or NO₃.

A twenty fourth aspect can include the reactor of any one of the first to twenty third aspects, wherein the at least one reaction product comprises carbon.

A twenty fifth aspect can include the reactor of any one of the first to twenty fourth aspects, wherein the portion of the surface of the interior of the reactor vessel is formed from molybdenum, niobium, tantalum, tungsten, rhenium, refractory materials, alloys thereof, oxides thereof, carbides thereof, and/or combinations thereof.

A twenty sixth aspect can include the reactor of any one of the first to twenty fifth aspects, wherein the portion of the surface of the interior of the reactor vessel is formed from ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, or any combination thereof.

A twenty seventh aspect can include the reactor of any one of the first to twenty sixth aspects, wherein the portion of the surface of the interior of the reactor vessel comprises a first material having a surface coating of molybdenum, niobium, tantalum, tungsten, rhenium, alloys thereof, carbides thereof, oxides thereof, or any combination thereof.

A twenty eighth aspect can include the reactor of any one of the first to twenty seventh aspects, wherein the portion of the surface of the interior of the reactor vessel comprises a smooth surface, a textured surface, a woven material or a mesh, or a porous surface.

In a twenty ninth aspect, a reactor comprises: a reactor vessel; one or more particulate beds disposed within the reactor vessel, where each particulate bed of the one or more particulate beds comprises a particulate material; and one or more inlets, where each inlet of the one or more inlets corresponds to each particulate bed of the one or more particulate beds, where each inlet is disposed below a corresponding particulate bed, and wherein the inlet is configured to introduce a fluid through the particulate bed to form a reaction channel within each the particulate bed of the one or more particulate beds.

A thirtieth aspect can include the reactor of the twenty ninth aspect, further comprising: the reaction channel extending between each inlet of the one or more inlets and an upper surface of each corresponding particulate bed.

A thirty first aspect can include the reactor of the twenty ninth or thirtieth aspect, further comprising a side inlet, wherein the side inlet is configured to pass a gas into the particulate bed from a side of the reactor vessel.

A thirty second aspect can include the reactor of any one of the twenty ninth to thirty first aspects, wherein the reactor vessel is formed from a porous material, and wherein the porous material is configured to allow a gas to pass through a wall of the reactor vessel into the particulate bed.

A thirty third aspect can include the reactor of any one of the twenty ninth to thirty second aspects, further comprising a particulate outlet, wherein the particulate outlet is configured to remove at least a portion of the particulate material from the reactor vessel.

A thirty fourth aspect can include the reactor of the thirty third aspect, further comprising: a particulate material inlet; and a recirculation loop, where the recirculation loop fluidly connects the particulate outlet with the particulate inlet, and wherein the recirculation loop is configured to pass the particulate material from the particulate outlet to the particulate inlet.

A thirty fifth aspect can include the reactor of any one of the twenty ninth to thirty fourth aspects, further comprising a heater, wherein the heater is configured to heat each particulate bed of the one or more particulate beds.

A thirty sixth aspect can include the reactor of any one of the twenty ninth to thirty fifth aspects, wherein the reactor vessel comprises a tapered bed having a diameter at a lower portion of the reactor that is smaller than a diameter at an upper portion of the reactor.

A thirty seventh aspect can include the reactor of any one of the twenty ninth to thirty sixth aspects, wherein the particulate bed is configured to prevent contact between a reaction product and a wall of the reactor vessel.

A thirty eighth aspect can include the reactor of any one of the twenty ninth to thirty seventh aspects, wherein the particulate material comprises carbon, sand, or any combination thereof.

In a thirty ninth aspect, a reaction process comprises: reacting a reactant gas in a reactor vessel; forming a solid product during the reacting; isolating at least a portion of a surface of an interior of the reactor vessel using a liquid film of a material; and preventing contact between the solid product and the portion of the surface of the interior of the reaction vessel based on the isolating.

A fortieth aspect can include the process of the thirty ninth aspect, where the reactor comprises a tubular reactor vessel.

A forty first aspect can include the process of the fortieth aspect, further comprising: heating the reactor vessel during the reacting.

A forty second aspect can include the process of the forty first aspect, wherein heating the reactor vessel comprises using inductive or resistive heating of the reactor vessel.

A forty third aspect can include the process of the thirty ninth aspect, wherein heating the reactor vessel comprises using a combustion product or heat transfer fluid to heat the reactor vessel.

A forty fourth aspect can include the process of the thirty ninth aspect, wherein the reactor vessel comprises: a liquid pool in a lower portion of the reactor vessel, where the liquid pool comprises a portion of the material; an array of tubes disposed within the reactor vessel, wherein a lower end of each tube of the array of tubes is disposed below an upper level of the material in the liquid pool, and wherein the liquid film is in contact with an interior surface of each tube of the array of tubes; and a plurality of nozzles, where each nozzle of the plurality of nozzles is associated with each tube of the array of tubes, and wherein the process further comprises: passing a feed gas through each nozzle; passing the feed gas through the material in the liquid pool; and passing the feed gas into each tube of the array of tubes, wherein at least a portion of the material is carried with the feed gas into each tube of the array of tubes.

A forty fifth aspect can include the process of the forty fourth aspect, wherein the reactor vessel further comprises: a tray, wherein an upper end of each tube of the plurality of tubes passes through the tray, wherein the process further comprises: directing the material passing through each tube to a circulation loop; and passing the material from the tray to the liquid pool through the circulation loop.

A forty sixth aspect can include the process of the forty fourth or forty fifth aspect, further comprising: contacting a heating fluid with an exterior of each tube of the array of tubes.

A forty seventh aspect can include the process of the thirty ninth aspect, wherein the reactor vessel comprises one or more tubular reactors, wherein the process further comprises: retaining at least a portion of the material in a liquid reservoir; and injecting the material into each corresponding tubular reactor of the one or more tubular reactors with the reactant gas.

A forty eighth aspect can include the process of the forty seventh aspect, further comprising: heating a first section of the one or more tubular reactors, wherein the reacting occurs in the first section; and cooling a second section of the one or more tubular reactors, wherein the second section is downstream from the first section.

A forty ninth aspect can include the process of the forty seventh or forty eighth aspect, further comprising: passing a product stream over a disengagement pool, wherein the disengagement pool comprises a portion of the material; and capturing at least a portion of the material in the product stream in the disengagement pool.

A fiftieth aspect can include the process of the thirty ninth aspect, wherein the reactor vessel contains one or more reactor tubes, wherein the one or more reactor tubes are formed from a porous material, wherein the process further comprises: passing a portion of the material through a wall of the one or more reactor tubes, wherein the material is retained in a liquid reservoir disposed within the reactor vessel, wherein the material is in contact with an exterior of the one or more reactor tubes; and passing a portion of the material through a wall of the one or more reactor tubes to wet an interior surface of the one or more reactor tubes.

A fifty first aspect can include the process of the fiftieth aspect, further comprising: heating the material in the liquid reservoir.

A fifty second aspect can include the process of the fiftieth aspect, further comprising: heating the material in a central reaction zone, wherein the liquid reservoir is disposed in the central reaction zone; heating the reactant gas in a preheat zone, wherein the preheat zone comprises a liquid in contact with a first portion of the one or more tubular reactors, where the first portion is upstream of the central reaction zone; cooling a product stream from the central reaction zone in a cooling zone, wherein the cooling zone comprises the liquid in contact with a second portion of the one or more tubular reactors, wherein the second portion is downstream of the central reaction zone; and circulating the liquid between the preheat zone and the cooling zone in a loop.

A fifty third aspect can include the process of the thirty ninth aspect, further comprising: introducing the material onto a packing material disposed within the reactor vessel, wherein the portion of the surface of an interior of the reactor vessel comprises at least a portion of the surface of the packing material; and forming the liquid film over at least a portion of the packing material.

A fifty fourth aspect can include the process of the fifty third aspect, further comprising: introducing a feed gas into the reactor vessel through a layer of the material, where the layer of the material is disposed in a lower portion of the packing material.

A fifty fifth aspect can include the process of the fifty fourth aspect, wherein the feed gas forms a continuous phase within the reactor vessel.

A fifty sixth aspect can include the process of the fifty fourth or fifty fifth aspect, further comprising: separating at least a portion of the material from a product stream leaving the reactor vessel.

A fifty seventh aspect can include the process of any one of the fifty fourth to fifty sixth aspects, further comprising: maintaining a temperature within the reactor vessel during the reacting.

A fifty eighth aspect can include the process of any one of the thirty ninth to fifty seventh aspects, wherein the material comprises a molten metal.

A fifty ninth aspect can include the process of the fifty eighth aspect, wherein the molten metal comprises Ag, Au, Sb, Sn, Bi, Ni, Cu, Fe, Pt, In, Pb, Pd, Co, Te, Rh, Ga, oxides thereof, and/or mixtures thereof.

A sixtieth aspect can include the process of any one of the thirty ninth to fifty ninth aspects, wherein the material comprises a molten salt.

A sixty first aspect can include the process of the sixtieth aspect, wherein the molten salt comprises one or more oxidized atoms (M)^{+m} and corresponding reduced atoms (X)⁻¹, wherein M comprises at least one of K, Na, Mg, Ca, Mn, Zn, Fe, La, or Li, and wherein X comprises at least one of F, Cl, Br, I, OH, SO₃, or NO₃-.

A sixty second aspect can include the process of any one of the thirty ninth to sixty first aspects, wherein the at least one reaction product comprises carbon.

A sixty third aspect can include the process of any one of the thirty ninth to sixty second aspects, wherein the portion of the surface of the interior of the reactor vessel is formed from molybdenum, niobium, tantalum, tungsten, rhenium, refractory materials, alloys thereof, oxides thereof, carbides thereof, and/or combinations thereof.

A sixty fourth aspect can include the process of any one of the thirty ninth to sixty third aspects, wherein the portion of the surface of the interior of the reactor vessel is formed from ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, or any combination thereof.

A sixty fifth aspect can include the process of any one of the thirty ninth to sixty fourth aspects, wherein the portion of the surface of the interior of the reactor vessel comprises a first material having a surface coating of molybdenum, niobium, tantalum, tungsten, rhenium, alloys thereof, carbides thereof, oxides thereof, or any combination thereof.

A sixty sixth aspect can include the process of any one of the thirty ninth to sixty fifth aspects, wherein the portion of the surface of the interior of the reactor vessel comprises a smooth surface, a textured surface formed from a woven material or a mesh, or a porous surface.

A sixty seventh aspect can include the process of any one of the thirty ninth to sixty sixth aspects, wherein the reactant gas and the material pass through the reactor vessel in an annular flow regime.

In a sixty eighth aspect, a reaction process comprises: introducing a fluid through a particulate bed of one or more particulate beds to form a reaction channel within each the particulate bed of the one or more particulate beds, where each particulate bed of the one or more particulate beds comprises a particulate material, and wherein the particulate bed is contained with a reaction vessel; reacting at least a portion of the fluid within the reaction channel; forming a solid product during the reacting; shielding at least a portion of a surface of an interior of the reactor vessel using the particulate bed; and preventing contact between the solid product and the portion of the surface of the interior of the reaction vessel based on the shielding.

A sixty ninth aspect can include the reactor of the sixty eighth aspect, wherein each reaction channel extends between each inlet of the one or more inlets and an upper surface of each corresponding particulate bed.

A seventieth aspect can include the reactor of the sixty eighth or sixty ninth aspect, further comprising: passing a gas into the particulate bed from a side of the reactor vessel.

A seventy first aspect can include the reactor of any one of the sixty eighth to seventieth aspects, wherein the reactor vessel is formed from a porous material, and wherein the porous material is configured to allow a gas to pass through a wall of the reactor vessel into the particulate bed.

A seventy second aspect can include the reactor of any one of the sixty eighth to seventy first aspects, further comprising: removing at least a portion of the particulate material from the particulate bed and the reactor vessel.

A seventy third aspect can include the reactor of the seventy second aspect, further comprising: passing, through a recirculation loop, the portion of particulate material removed from the reactor vessel from a particulate outlet of the reaction vessel to a particulate inlet of the reactor vessel.

A seventy fourth aspect can include the reactor of any one of the sixty eighth to seventy third aspects, further comprising: heating each particulate bed of the one or more particulate beds during the reacting.

A seventy fifth aspect can include the reactor of any one of the sixty eighth to seventy fourth aspects, wherein the reactor vessel comprises a tapered bed having a diameter at a lower portion of the reactor that is smaller than a diameter at an upper portion of the reactor.

A seventy sixth aspect can include the reactor of any one of the sixty eighth to seventy fifth aspects, wherein the particulate material comprises carbon, sand, or any combination thereof.

In a seventy seventh aspect, a composition comprises: a substrate; a coating formed on a surface of the substrate; and a material disposed on the coating; wherein the material is selected to form a wetting film on the coating when the material is in a liquid state.

A seventy eighth aspect can include the composition of the seventy seventh aspect, wherein the coating comprises molybdenum, niobium, tantalum, tungsten, rhenium, alloys thereof, carbides thereof, oxides thereof, or composites thereof.

A seventy ninth aspect can include the composition of the seventy seventh or seventy eighth aspect, where the substrate comprises a ceramic.

An eightieth aspect can include the composition of any one of the seventy seventh to the seventy ninth aspects, wherein the substrate comprises: ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, a carbonaceous resin, a glassy carbon, a carbon fiber, graphite, a high nickel alloy, or any combination thereof.

An eighty first aspect can include the composition of any one of the seventy seventh to the eightieth aspects, wherein the coating has a thickness between about 1 micrometer to about 200 micrometers.

An eighty second aspect can include the composition of any one of the seventy seventh to the eighty first aspects, further comprising: a second coating formed on a surface of the coating, wherein the second coating has a different composition than a composition of the coating.

An eighty third aspect can include the composition of any one of the seventy seventh to the eighty second aspects, wherein the substrate and the coating are selected to react at an interface between the substrate and the coating.

An eighty fourth aspect can include the composition of any one of the seventy seventh to the eighty third aspects, wherein the substrate is porous.

In an eighty fifth aspect, a method of forming a composition comprises: disposing a coating on a surface of a substrate; and wetting the coating with a material, wherein the material is selected to form a wetting film on the coating when the material is in a liquid state.

An eighty sixth aspect can include the method of the eighty fifth aspect, wherein disposing the coating on the surface comprises: reducing a metal halide or a carbonyl; and depositing the coating on the surface based on the reducing of the metal halide or the carbonyl.

An eighty seventh aspect can include the method of the eighty sixth aspect, wherein the reducing comprises reducing the metal halide or the carbonyl in a high vacuum chamber using a reductant.

An eighty eighth aspect can include the method of the eighty sixth or eighty seventh aspect, wherein the metal halide comprises WF₆, (MoCl₅)₂, TaCl₅, NbCl₅, ReCl₅, or any combination thereof.

An eighty ninth aspect can include the method of the eighty sixth or eighty seventh aspect, wherein the carbonyl comprises W(CO)₆, Mo(CO)₆, Ta(CO)₆, Re₂(CO)₁₀, Nb₂(CO)₁₂ or any combination thereof.

A ninetieth aspect can include the method of the eighty fifth aspect, wherein disposing the coating on the surface of the substrate uses a plasma-spray deposition process.

A ninety first aspect can include the method of any one of the eighty fifth to ninetieth aspects, wherein disposing the coating on the surface occurs at a temperature above about 400° C. and below about 1,500° C.

A ninety second aspect can include the method of the eighty fifth aspect, wherein disposing the coating on the surface of the substrate uses an electrochemical deposition process.

A ninety third aspect can include the method of the ninety second aspect, wherein the electrochemical deposition process uses a molten salt electrochemical deposition process.

A ninety fourth aspect can include the method of the ninety second aspect, wherein disposing the coating on the surface of the substrate uses a wet impregnation and reduction process.

In a ninety fifth aspect, a system comprises: a substrate; and a coating formed on a surface of the substrate, wherein the coating comprises molybdenum, niobium, tantalum, tungsten, rhenium, alloys thereof, carbides thereof, oxides thereof, or composites thereof.

A ninety sixth aspect can include the system of the ninety fifth aspect, further comprising: a material disposed on the coating; wherein the material is selected to form a wetting film on the coating when the material is in a liquid state.

A ninety seventh aspect can include the system of the ninety fifth or ninety sixth aspect, wherein the substrate having the coating and the material disposed on the coating are disposed within a reactor vessel.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

1. A reactor comprising:
a reactor vessel;
a liquid film in contact with and coating at least a portion of a surface of an interior of the reactor vessel; and
one or more reaction products in contact with the liquid film within the reactor vessel, wherein the liquid film is configured to wet at least a portion of the surface of the interior of the reactor vessel, and wherein the liquid film is formed from a material that inhibits the deposition of at least one reaction product of the one or more reaction products on the surface of the interior of the reactor vessel.

2.-3. (canceled)

4. The reactor of claim 1, wherein the reactor vessel comprises:
a liquid pool in a lower portion of the reactor vessel, where the liquid pool comprises a portion of the material;
an array of tubes disposed within the reactor vessel, wherein a lower end of each tube of the array of tubes is disposed below an upper level of the material in the liquid pool, and wherein the liquid film is in contact with an interior surface of each tube of the array of tubes; and
a plurality of nozzles, where each nozzle of the plurality of nozzles is associated with each tube of the array of tubes, and wherein each nozzle is configured to receive a feed gas and pass the feed gas through the material in the liquid pool before passing the feed gas into each tube of the array of tubes.

5.-6. (canceled)

7. The reactor of claim 1, wherein the reactor vessel contains one or more reactor tubes, wherein the one or more reactor tubes are formed from a porous material, wherein the reactor further comprises:
a liquid reservoir comprising the material disposed within the reactor vessel, wherein the material is in contact with an exterior of the one or more reactor tubes, wherein the one or more reactor tubes are configured to pass a portion of the material through a wall of the one or more reactor tubes to wet an interior surface of the one or more reactor tubes.

8. The reactor of claim 1, further comprising:
a packing material disposed within the reactor vessel;
a material inlet disposed above the packing material in the reactor vessel; and
a material outlet disposed in a lower portion of the reactor vessel, wherein the material inlet is configured to introduce the material onto the packing material within the reactor vessel and form the liquid film over at least a portion of the packing material.

9. The reactor of claim 8, further comprising:
a gas inlet disposed below the packing material and configured to introduce a feed gas into the reactor vessel through a layer of the material.

10. The reactor of claim 1, wherein the material comprises a molten metal, and wherein the molten metal comprises Ag, Au, Sb, Sn, Bi, Ni, Cu, Fe, Pt, In, Pb, Pd, Co, Te, Rh, Ga, oxides thereof, and/or mixtures thereof.

11. The reactor of claim 1, wherein the material comprises a molten salt, and wherein the molten salt comprises one or more oxidized atoms (M)^{+m} and corresponding reduced atoms (X)₋₁, wherein M comprises at least one of K, Na, Mg. Ca, Mn, Zn, Fe, La, or Li, and wherein X comprises at least one of F, Cl, Br, I, OH, SO₃, or NO₃-.

12. (canceled)

13. The reactor of claim 9, wherein the at least one reaction product comprises carbon.

14. The reactor of claim 1, wherein the portion of the surface of the interior of the reactor vessel is formed from molybdenum, niobium, tantalum, tungsten, rhenium, refractory materials, alloys thereof, oxides thereof, carbides thereof, and/or combinations thereof.

15. The reactor of claim 1, wherein the portion of the surface of the interior of the reactor vessel is formed from ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, or any combination thereof.

16. The reactor of claim 1, wherein the portion of the surface of the interior of the reactor vessel comprises a first material having a surface coating of molybdenum, niobium, tantalum, tungsten, rhenium, alloys thereof, carbides thereof, oxides thereof, or any combination thereof.

17.-22. (canceled)

23. A reaction process comprising:
reacting a reactant gas in a reactor vessel;
forming a solid product during the reacting;
isolating at least a portion of a surface of an interior of the reactor vessel using a liquid film of a material; and
preventing contact between the solid product and the portion of the surface of the interior of the reaction vessel based on the isolating.

24.-25. (canceled)

26. The process of claim 23, wherein the reactor vessel comprises:
a liquid pool in a lower portion of the reactor vessel, where the liquid pool comprises a portion of the material;
an array of tubes disposed within the reactor vessel, wherein a lower end of each tube of the array of tubes is disposed below an upper level of the material in the liquid pool, and wherein the liquid film is in contact with an interior surface of each tube of the array of tubes; and
a plurality of nozzles, where each nozzle of the plurality of nozzles is associated with each tube of the array of tubes, and wherein the process further comprises:
passing a feed gas through each nozzle;
passing the feed gas through the material in the liquid pool; and
passing the feed gas into each tube of the array of tubes, wherein at least a portion of the material is carried with the feed gas into each tube of the array of tubes.

27. The process of claim 26, wherein the reactor vessel further comprises:
a tray, wherein an upper end of each tube of the plurality of tubes passes through the tray, wherein the process further comprises
directing the material passing through each tube to a circulation loop; and
passing the material from the tray to the liquid pool through the circulation loop.

28. The process of claim 23, wherein the reactor vessel contains one or more reactor tubes, wherein the one or more reactor tubes are formed from a porous material, wherein the process further comprises:
passing a portion of the material through a wall of the one or more reactor tubes, wherein the material is retained in a liquid reservoir disposed within the reactor vessel, wherein the material is in contact with an exterior of the one or more reactor tubes; and
passing a portion of the material through a wall of the one or more reactor tubes to wet an interior surface of the one or more reactor tubes.

29. The process of claim 28, further comprising:
heating the material in a central reaction zone, wherein the liquid reservoir is disposed in the central reaction zone;
heating the reactant gas in a preheat zone, wherein the preheat zone comprises a liquid in contact with a first portion of the one or more tubular reactors, where the first portion is upstream of the central reaction zone;
cooling a product stream from the central reaction zone in a cooling zone, wherein the cooling zone comprises the liquid in contact with a second portion of the one or more tubular reactors, wherein the second portion is downstream of the central reaction zone; and
circulating the liquid between the preheat zone and the cooling zone in a loop.

30.-31. (canceled)

32. The process of claim 23, wherein the material comprises a molten metal, and wherein the molten metal comprises Ag, Au, Sb, Sn, Bi, Ni, Cu, Fe, Pt, In, Pb, Pd, Co, Te, Rh, Ga, oxides thereof, and/or mixtures thereof.

33.-34. (canceled)

35. The process of claim 23, wherein the at least one reaction product comprises carbon.

36. The process of claim 23, wherein the portion of the surface of the interior of the reactor vessel is formed from molybdenum, niobium, tantalum, tungsten, rhenium, refractory materials, alloys thereof, oxides thereof, carbides thereof, and/or combinations thereof.

37. The process of claim 23, wherein the portion of the surface of the interior of the reactor vessel is formed from ZrO₂, Y₂O₃, Cr₂O₃, CaO, MgO, Al₂O₃, SiO₂, CeO₂, La₂O₃, Fe₂O₃, Na₂O, K₂O, B₂O₃, P₂O₅, AlN, Si₃N₄, BN, SiC, B₄C, carbonaceous resins, glassy (vitreous) carbon, carbon fiber, graphite, or any combination thereof, and wherein the portion of the surface of the interior of the reactor vessel comprises a first material having a surface coating of molybdenum, niobium, tantalum, tungsten, rhenium, alloys thereof, carbides thereof, oxides thereof, or any combination thereof.

38.-53. (canceled)
